(19) United States
(12) Patent Application Publication
(10) Pub. No.: US 2025/0125984 A1
(43) Pub. Date: Apr. 17, 2025

(54) METHODS AND APPARATUS TO SAVE POWER DURING CONFERENCE CALLS

(71) Applicant: Intel Corporation, Santa Clara, CA (US)

(72) Inventors: Wey-Yi Guy, Beaverton, OR (US); Tao Tao, Portland, OR (US); Venkateshan Udhayan, Portland, OR (US); Sean J. W. Lawrence, Bangalore (IN); Perazhi Sameer Kalathil, Bangalore (IN); Vishal Ravindra Sinha, Portland, OR (US)

(73) Assignee: Intel Corporation, Santa Clara, CA (US)

(21) Appl. No.: 18/990,563

(22) Filed: Dec. 20, 2024

(51) Int. Cl. H04L 12/18; G06F 1/3209

(52) U.S. Cl. CPC H04L 12/1822; G06F 1/3209; H04L 12/1827; H04L 12/1868

(57) ABSTRACT

Systems, apparatus, articles of manufacture, and methods to save power during conference calls are disclosed. An example first client device includes interface circuitry; machine readable instructions; and at least one processor circuit to at least one of instantiate or execute the machine readable instructions to: determine whether a first attendee of a conference call is absent from the first client device; and cause transmission of a notification to at least one of a server for the conference call or a second client device associated with the conference call and different from the first client device, the notification to cause the second client device to change an operating state associates with the conference call.

### BACKGROUND

Technological advancements have enabled people to communicate with one another from remote locations in substantially real-time. Furthermore, such communication methods are no longer limited to written or spoken messages, but include real-time video messages such as during video conference calls.

### BRIEF DESCRIPTION OF THE DRAWINGS

FIG. 1 illustrates an example network of client devices connected to a video conference call.

FIG. 2 is a block diagram of an example implementation of the example conference control circuitry in any one of the example client devices of FIG. 1.

FIG. 3 is a block diagram of an example implementation of the example conferencing server of FIG. 1.

FIG. 4-6 are flowcharts representative of example machine readable instructions and/or example operations that may be executed, instantiated, and/or performed by example programmable circuitry to implement the example conference control circuitry of FIG. 2.

FIGS. 7A and 7B is a flowchart representative of example machine readable instructions and/or example operations that may be executed, instantiated, and/or performed by example programmable circuitry to implement the example conferencing server of FIG. 3.

FIG. 8 is a block diagram of an example processing platform including programmable circuitry structured to execute, instantiate, and/or perform the example machine readable instructions and/or perform the example operations of FIGS. 4-6 to implement the example conference control circuitry of FIG. 2.

FIG. 9 is a block diagram of an example processing platform including programmable circuitry structured to execute, instantiate, and/or perform the example machine readable instructions and/or perform the example operations of FIGS. 7A and 7B to implement the example conferencing server of FIG. 3.

FIG. 10 is a block diagram of an example implementation of the programmable circuitry of FIGS. 8 and/or 9.

FIG. 11 is a block diagram of another example implementation of the programmable circuitry of FIGS. 8 and/or 9.

FIG. 12 is a block diagram of an example software/firmware/instructions distribution platform (e.g., one or more servers) to distribute software, instructions, and/or firmware (e.g., corresponding to the example machine readable instructions of FIGS. 4-6 and/or 7A and 7B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A real-time conference call requires attendees of the call to have an electronic device or system (e.g., a smartphone, a tablet, a laptop, a desktop computer, etc.) that is capable of at least (1) capturing audio and video of the attendees associated (e.g., via a microphone and camera), (2) transmitting and receiving the captured audio and video between devices (e.g., via network interface circuitry), and (3) presenting the audio and video captured by the other attendees (e.g., via a speaker and a display). The capturing and associated processing (e.g., encoding) of audio and video as well as the receiving and associated processing (e.g., decoding) of such data involves relatively significant computational resources. Furthermore, the transmitting and receiving of such data between devices involves relatively significant demands on network bandwidth.

There are times during conference calls when one or more attendees may leave their computer or other electronic device used to connect to a conference call. In such situations, the electronic device may continue to capture and stream video corresponding to the field of view of an associated camera. This situation leads to a significant waste of computational resources and energy consumption by both the local and remote computers. In this context, as used herein, the terms “local” and “remote” are used in connection with a given attendee or participant in a conference call. Specifically, the computer or device with which a particular attendee joins a call is a “local” computer or device computer while other computers or devices used by other attendees are “remote” computers or devices. Thus, a “local” device for one attendee is a “remote” device from the perspective of other attendees and vice versa. There is a waste in computational resources on both local and remote computers when a conference call participant leaves their computer because the local computer (from the perspective of the absent participant) is capturing and processing audio and video that does not include any meaningful content because the participant is not there. Further, a remote device wastes computational resources in receiving and processing such audio and video data containing no meaningful content. Furthermore, if it is a conference call between two participants and one is absent, the computer of the participant that is still present (e.g., the remote computer from the perspective of the absent participant) wastes resources in capturing and processing audio and video of the participant that remains present because it is not being perceived by the other participant because the other participant is absent from their computer where such data is being presented. In addition to the waste in computational resources at both the local and remote devices relative to an absent conference call attendee, the continuous streaming of video data when it is no longer necessary contributes to increased network traffic and power usage, which is both inefficient and environmentally unfriendly.

Some known video streaming systems are able to detect when no one is present or when there is nothing to capture within the field of view of a camera. These systems can optimize non-video conferencing applications by either dimming the display, turning off the display, or putting the system into a sleep or off state. This feature is disabled for video conferencing applications. For video conferencing usage, the client video encoder can detect that there are no changes in the camera capture frame and optimize compression to reduce network bandwidth and, hence, power consumption. However, such known systems cannot completely reduce and/or stop the capturing, processing, and/or transmission of the video stream to improve computational and power efficiencies and reduce bandwidth usage of the local device capturing the video. Moreover, there is no system that implements a feedback loop between different computers to enable other devices (remote from the local device) to adjust their operation for improved efficiency in response to a conference call attendee becoming absent at the local device.

Examples disclosed herein provide a solution to the above problem that enables the accurate and prompt identification of when a conference call participant is no longer present or attentive and take appropriate action to reduce unnecessary power consumption and network bandwidth usage on both the local device (where the participant is absent) and remote devices (where other participants are still present) without disrupting the user experience for the active participants at the remote devices.

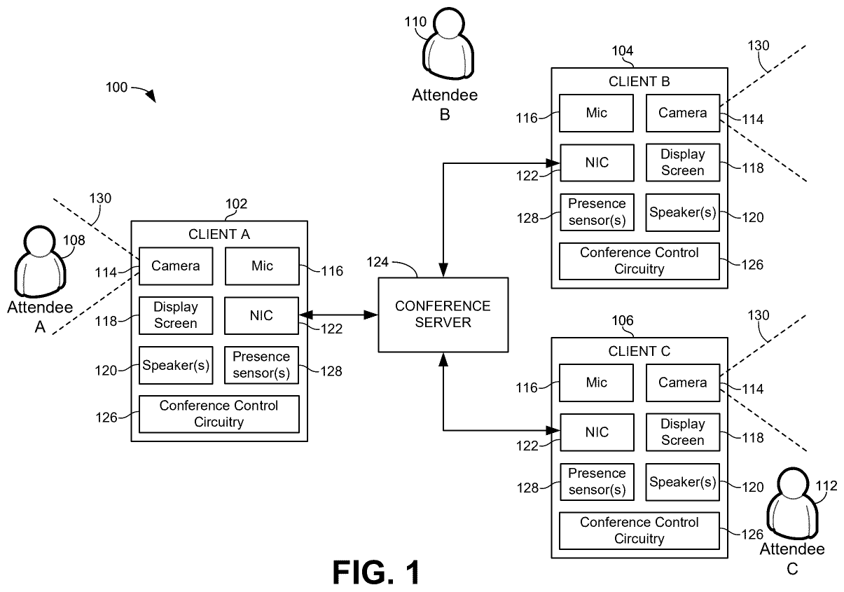

FIG. 1 illustrates an example network 100 of client devices 102, 104, 106 connected in a video conference call. In this example, the client devices 102, 104, 106 can be any type of computer or other electronic device (e.g., smartphone, tablet, laptop, desktop computer, etc.) that enables an associated user 108, 110, 112 to join to a video conference call. The users 108, 110, 112 are referred to herein as attendees or participants of the conference call. As shown in the illustrated example, each client device 102, 104, 106 includes a camera 114 to capture a video stream of the corresponding attendee 108, 110, 112. In some examples, one or more of the client devices 102, 104, 106 includes more than one camera 114. Further, each client device 102, 104, 106 includes a microphone 116 to capture audio of the corresponding attendee 108, 110, 112. In some examples, one or more of the client devices 102, 104, 106 includes more than one microphone 116. Additionally, each client device 102, 104, 106 includes a display screen 118 to present the video captured and provided from the other client devices 102, 104, 106. In some examples, one or more of the client devices 102, 104, 106 includes more than one display screen 118. Furthermore, each client device 102, 104, 106 includes one or more speakers 120 to provide the audio captured and provided from the other client devices 102, 104, 106.

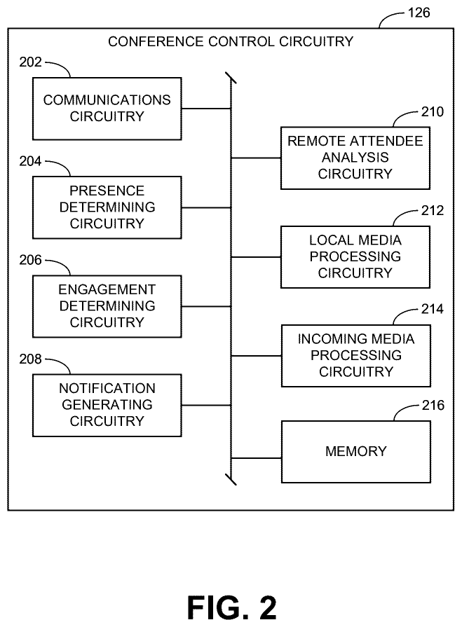

In the illustrated example, each client device 102, 104, 106 includes network interface circuitry 122 (e.g., a network interface card (NIC)) to enable connection to a network, such as the Internet. In this example, the different client devices 102, 104, 106 are connected via a conference server 124. That is, in some examples, the conference server 124 hosts a conference call to which the client devices 102, 104, 106 are connected. In some examples, the conference server 124 provides functionality associated with a conference call application executed and/or instantiated by the conference control circuitry 126 associated with each client device 102, 104, 106. Further detail regarding the implementation of the conference control circuitry 126 is provided further below in connection with FIG. 2. In some examples, the conference server 124 is a cloud server that is remote from all of the client devices 102, 104, 106. In some examples, the conference server 124 is omitted and the client devices 102, 104, 106 are part of a network of peer-to-peer connections.

As shown in the illustrated example, each of the client devices 102, 104, 106 includes one or more presence sensor(s) 128 to detect the presence of each associated attendee 108, 110, 112. As used herein, an attendee is “present” for a video conference call when the attendee is within the field of view of an associated camera. In the illustrated example of FIG. 1, the field of view 130 of each camera 114 is represented by dashed lines emanating from the camera 114. Thus, as shown in the illustrated example, the first attendee 108 (e.g., Attendee A) is present at the first client device 102 (e.g., Client A). By contrast, both the second and third attendees 110, 112 (e.g., Attendee B and Attendee C) are outside the field of view 130 of the cameras 114 of their respective client devices 104, 106 (e.g., Client B and Client C) and, thus, are considered “absent” from the conference call as the term is used herein. In some examples, attendees are considered absent from a conference call even when they remain within the field of view 130 of a camera 114 if they are a threshold distance away from the camera 114 and/or take up less than a threshold area of an image frame captured by the camera 114.

Notably, while both the second and third attendees 110, 112 are absent, as the term is defined herein, the circumstances of the two attendees is not the same. In the example shown in FIG. 1, the second attendee 110 is completely spaced apart from the associated second client device 104, whereas the third attendee 112 is still relatively close to the client device 106 (though not within the field of view 130 of the associated camera 114). In the case of the third attendee 112, it is possible that the third attendee 112 is able to see the display screen 118 and/or hear the audio produced by the speaker(s) 120. As such, although “absent” from the call (based on being outside the field of view 130 of the camera 114), the third attendee 112 may nevertheless still be engaged in the conference call to at least some extent. Accordingly, in some examples, the presence sensor(s) 128 also detect and/or determine a level of engagement of an attendee while they are absent (e.g., not visible within the field of view 130 of the camera 114). In some examples, different levels of engagement include (1) completely disengaged, (2) engaged only in audio, and (3) fully engaged.

As used herein, a conference call attendee is “completely disengaged” from the conference call when the attendee is not paying attention to the video associated with the call and also not paying attention to the audio associated with the call. An example of this is when an attendee 108, 110, 112 walks away from the associated client device 102, 104, 106 and both the display screen 118 and the speaker(s) 120 remain at the location of the client device 102, 104, 106. In the illustrated example of FIG. 1, the second attendee 110 represents someone that is completely disengaged with the conference call.

As used herein, a conference call attendee is “engaged only in audio” of the conference call when the attendee is not paying attention to the video stream but continues to be able to hear the associated audio and/or can speak on the conference call. This can occur when the attendee remains in proximity to (e.g., within earshot of the speaker(s) 120 of) their local client device but moves to a position where they are no longer viewing the display screen 118. This can also occur in situations where the audio is provided through a headset, earphones, headphones, or other portable speaker that is carried by the attendee and communicatively coupled to the client device to serve the function of the speaker(s) 120. In some such examples, the headset, earphones, headphones, or other portable speaker may also include a microphone that serves the function of the microphone 116. Thus, if the second attendee 110 in FIG. 2 had a headset in communication with the second client device 104, the second attendee could be considered to be engaged only in audio associated with the conference call. Another scenario in which an attendee is engaged only in audio is when the attendee minimizes the conference application within the display screen 118 showing the video and/or opens a different application on the client device 104 that covers the video conference application within the display screen 118.

As used herein, a conference call attendee is “fully engaged” in the conference call when the attendee is paying attention to both the video stream and the associated audio. In many circumstances, an attendee is going to be present within the field of view 130 of the camera 114 when the attendee is fully engaged, but this is not necessarily the case. In some situations, the attendee can be outside of the field of view 130 of the camera 114 (and, thus, absent) but still be positioned to see the video on the display screen 118 and hear the audio from the associated speaker(s) 120. In the illustrated example of FIG. 1, the third attendee 112 represents someone that is absent from the conference call (e.g., outside the field of view 130 of the camera 114) but still fully engaged with the conference call.

Determining the presence or absence of an attendee 108, 110, 112 and determining the level of engagement of the attendee 108, 110, 112 when absent can be accomplished in any number of ways. Thus, the presence sensor(s) 128 can include any suitable types of sensors (e.g., depth sensors, location sensors, etc.). In some examples, the camera 114 and/or the microphone 116 serve as presence sensors. Thus, in some examples, other presence sensor(s) 128 may be omitted. However, in other examples, different presence sensor(s) 128 other than the camera 114 and/or the microphone 116 can additionally or alternatively be used.

Although three client devices 102, 104, 106 are shown in the illustrated example of FIG. 1, any other suitable number of client devices can be connected to a conference call (including just two devices or more than three devices). Further, although each client device 102, 104, 106 is represented in a similar manner in FIG. 1, the client devices 102, 104, 106 can be different from one another. For instance, different client devices 102, 104, 106, can have different numbers and/or types of cameras 114, microphones 116, display screens 118, speaker(s) 120, network interface circuitry 122, and/or presence sensor(s) 128. Further, in some examples, one or more of the client devices 102, 104, 106 is an integrated unit with each of the cameras 114, microphones 116, display screens 118, speaker(s) 120, network interface circuitry 122, and presence sensor(s) 128 carried in a common housing. In other examples, one or more of the camera 114, the microphones 116, the display screen 118, the speaker(s) 120, the network interface circuitry 122, and/or the presence sensor(s) 128 are implemented in one or more separate (e.g., peripheral) components that are operatively coupled together. In some examples, the components are communicatively coupled with a wired connection. Additionally or alternatively, in some examples, the components of one or more of the client devices 102, 104, 106 are communicatively coupled via a wireless connection (e.g., in the case of a wireless headset used for the microphone 116 and/or the speaker(s) 120 as mentioned above).

FIG. 2 is a block diagram of an example implementation of the conference control circuitry 126 in any one of the client devices 102, 104, 106 of FIG. 1 to facilitate a conference call and control operation of at least one of the camera 114, the microphones 116, the display screen 118, the speaker(s) 120, the network interface circuitry 122, and/or the presence sensor(s) 128. The conference control circuitry 126 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the conference control circuitry 126 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example conference control circuitry 126 includes example communications circuitry 202, example presence determining circuitry 204, example engagement determining circuitry 206, example notification generating circuitry 208, example remote attendee analysis circuitry 210, example local media processing circuitry 212, example incoming media processing circuitry 214, and example memory 216.

In the illustrated example of FIG. 2, the conference control circuitry 126 includes the example communications circuitry 202 to facilitate communications between the conference control circuitry 126 and other components of the associated client device 102, 104, 106. In some examples, the communications circuitry 202 includes and/or is associated with the network interface circuitry 122 to enable communications with devices external to and separate from the client device 102, 104, 106 (e.g., the conference server 124 and/or other ones of the client devices 102, 104, 106).

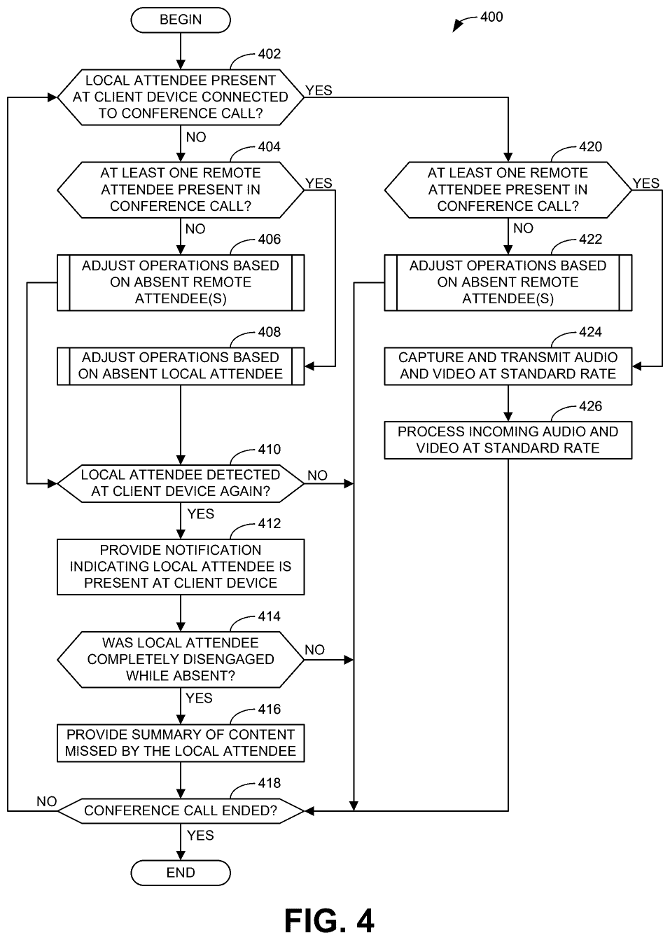

In some examples, the communications circuitry 202 is instantiated by programmable circuitry executing communications instructions and/or configured to perform operations such as those represented by the flowchart(s) of FIGS. 4-6.

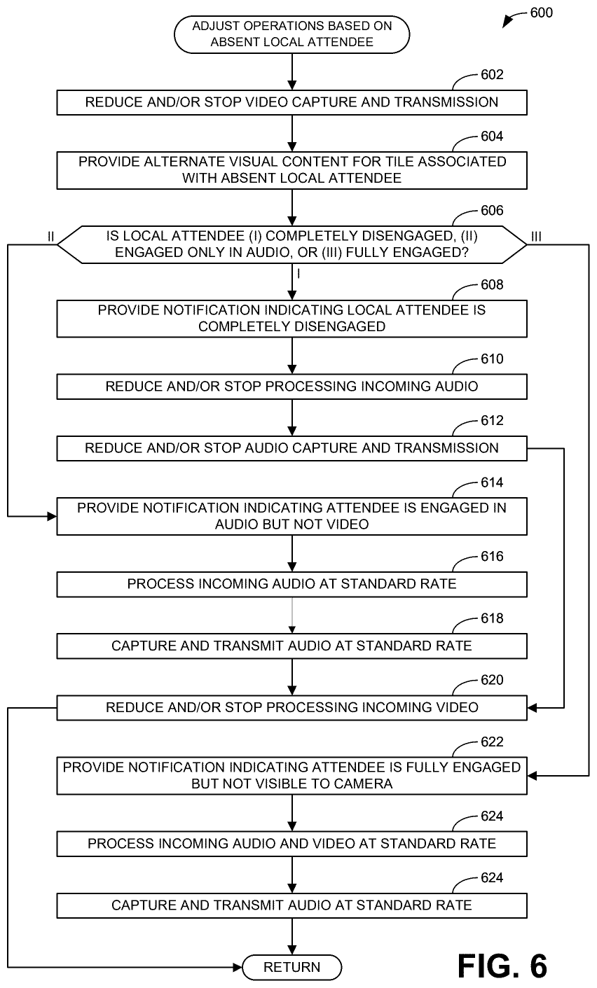

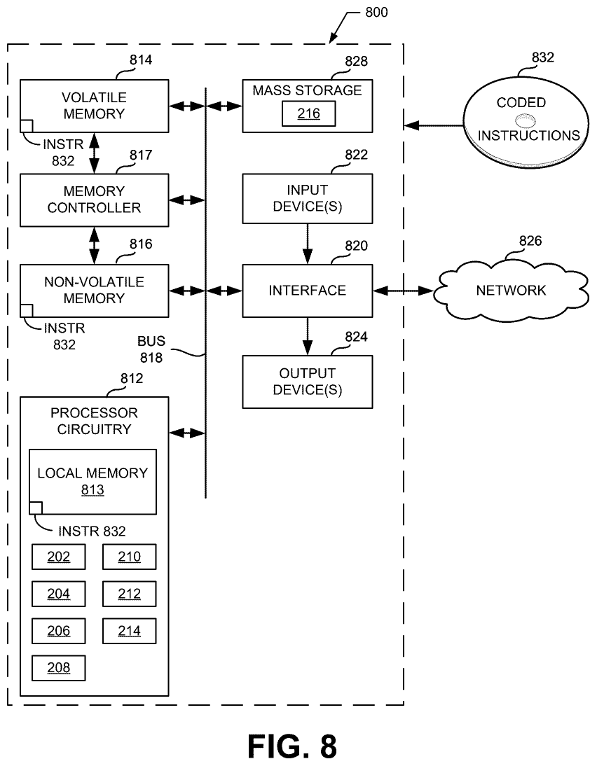

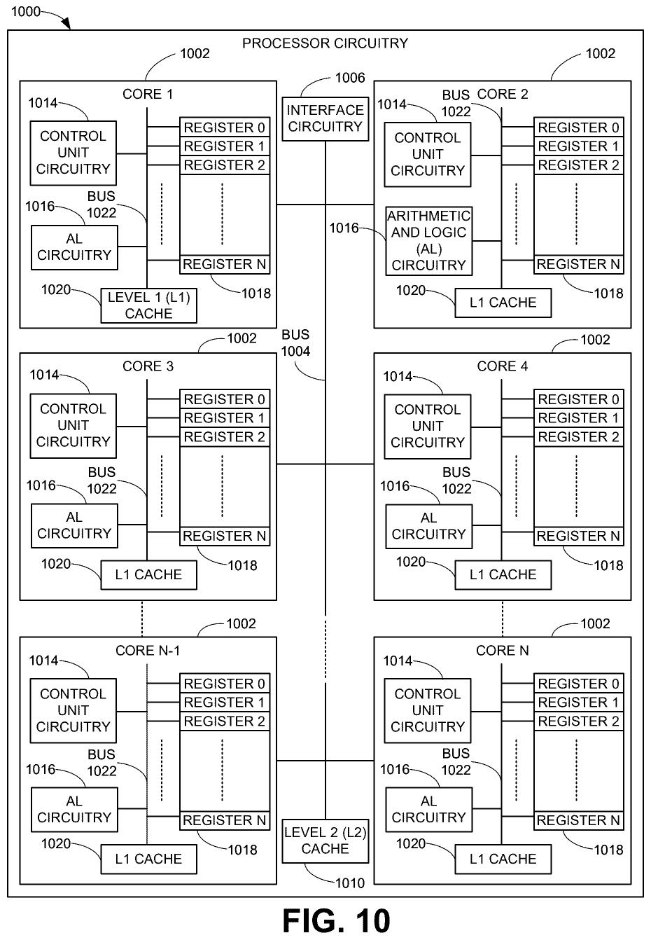

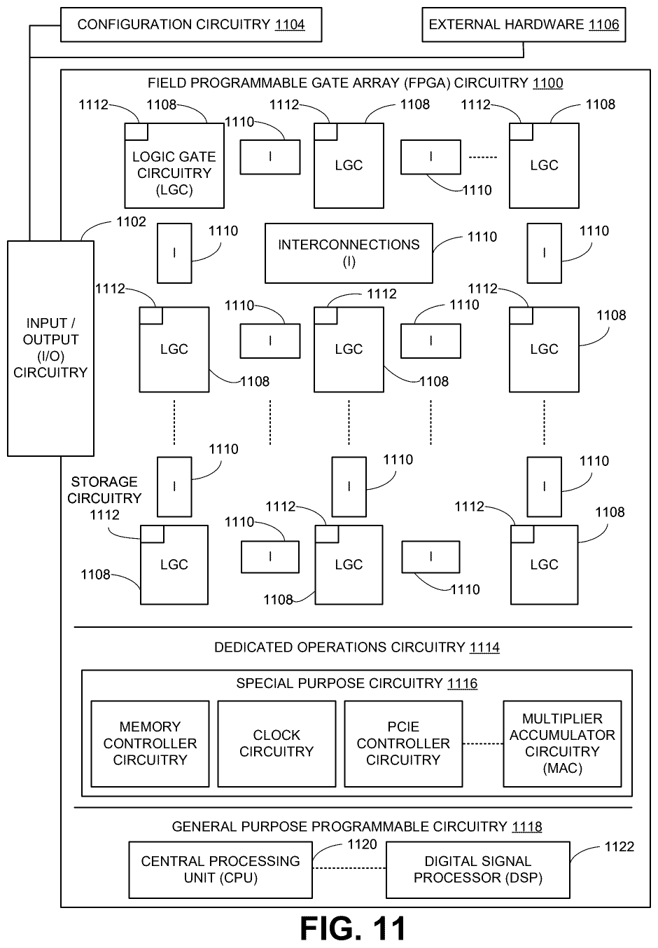

In some examples, the conference control circuitry 126 includes means for communicating. For example, the means for communicating may be implemented by communications circuitry 202. In some examples, the communications circuitry 202 may be instantiated by programmable circuitry such as the example programmable circuitry 812 of FIG. 8. For instance, the communications circuitry 202 may be instantiated by the example microprocessor 1000 of FIG. 10 executing machine executable instructions such as those implemented by at least block 412 of FIG. 4 and blocks 608, 614, and 622 of FIG. 6. In some examples, the communications circuitry 202 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the communications circuitry 202 may be instantiated by any other combination of hardware, software, and/or firmware. For example, the communications circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example presence determining circuitry 204 to determine whether the local attendee (e.g., the attendee 108, 110, 112 associated with the corresponding client device 102, 104, 106) is present or absent in a conference call to which the associated client device 102, 104, 106 is connected. As discussed above, an attendee 108, 110, 112 is considered absent from a conference call when the attendee 108, 110, 112 is not visible within the field of view 130 of an associated camera 114. Accordingly, in some examples, a presence determination is based on an analysis of a video stream captured by the camera 114. In some examples, presence detection is based on motion detection, facial recognition, body posture analysis, and/or eye tracking (e.g., gaze tracking). In some examples, such analysis can be based on a machine learning model such as a convolutional neural network (CNN).

Additionally or alternatively, in some examples, an attendee 108, 110, 112 is considered absent from a conference call when the attendee 108, 110, 112 is within the field of view 130 but is relatively far away from the camera 114. In some examples, this is determined based on the attendee 108, 110, 112 being at least a threshold distance away from the camera 114 (e.g., as determined by a depth sensing presence sensor 128) and/or the attendee 108, 110, 112 being smaller than a threshold area of an image frame captured by the camera 114 (e.g., as determined by an analysis of the image frame). In some examples, the presence determining circuitry 204 additionally or alternatively uses inputs from other types of presence sensor(s) 128 (e.g., the microphone 116, a location sensor (e.g., a global position system (GPS) tracker, radio antenna beam formers, etc.) to determine the presence of an attendee 108, 110, 112. In some examples, multiple independent presence sensors 128 are used to provide a multi-modal basis for the presence determination to reduce the occurrence of false positives and/or false negatives (e.g., determining an attendee is absent when present or determining an attendee is present when absent). Additionally or alternatively, in some examples, the presence determining circuitry 204 determines an attendee 108, 110, 112 switches between being present to absent only after a threshold period of time to, for example, avoid flagging the attendee 108, 110, 112 as absent when the attendee 108, 110, 112 merely stepped away momentarily.

In some examples, the presence determining circuitry 204 is instantiated by programmable circuitry executing presence determining instructions and/or configured to perform operations such as those represented by the flowchart(s) of FIGS. 4-6.

In some examples, the conference control circuitry 126 includes means for determining the presence of an attendee of a conference call. For example, the means for determining may be implemented by presence determining circuitry 204. In some examples, the presence determining circuitry 204 may be instantiated by programmable circuitry such as the example programmable circuitry 812 of FIG. 8. For instance, the presence determining circuitry 204 may be instantiated by the example microprocessor 1000 of FIG. 10 executing machine executable instructions such as those implemented by at least blocks 402, 410 of FIG. 4. In some examples, the presence determining circuitry 204 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the presence determining circuitry 204 may be instantiated by any other combination of hardware, software, and/or firmware. For example, the presence determining circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example engagement determining circuitry 206 to determine the level of engagement of the local attendee (e.g., the attendee 108, 110, 112 that used the corresponding client device 102, 104, 106 to join the conference call). In some examples, the engagement determining circuitry 206 determines the level of engagement only after the presence determining circuitry 204 has determined that an attendee is absent. In other examples, the engagement determining circuitry 206 determines the level of engagement of an attendee 108, 110, 112 regardless of whether the attendee 108, 110, 112 is absent or present.

In some examples, the engagement determining circuitry 206 distinguishes between multiple different levels of engagement including whether the local attendee is fully engaged in a conference call (e.g., paying attention to both audio and video), engaged in audio but not video (e.g., partially engaged) in the conference call, or completely disengaged from the conference call (e.g., not paying attention to the audio and not paying attention to the video). In some examples, the level of engagement is determined based on the location and/or position of the attendee 108, 110, 112 relative to the display screen 118 and/or the speaker(s) 120 of the associated local client device 102, 104, 106. In some such examples, the engagement determining circuitry 206 determines the location and/or position of the attendee 108, 110, 112 using similar techniques and/or similar inputs from similar presence sensor(s) 128 used by the presence determining circuitry 204 to determine the presence or absence of the attendee 108, 110, 112 discussed above. Additionally or alternatively, in some examples, the engagement determining circuitry 206 determines the level of engagement of an attendee using different inputs, different sensors 128, and/or different techniques.

In some examples, the engagement determining circuitry 206 is instantiated by programmable circuitry executing engagement determining instructions and/or configured to perform operations such as those represented by the flowchart(s) of FIGS. 4-6.

In some examples, the conference control circuitry 126 includes means for determining a level of engagement of an attendee of a conference call. For example, the means for determining may be implemented by engagement determining circuitry 206. In some examples, the engagement determining circuitry 206 may be instantiated by programmable circuitry such as the example programmable circuitry 812 of FIG. 8. For instance, the engagement determining circuitry 206 may be instantiated by the example microprocessor 1000 of FIG. 10 executing machine executable instructions such as those implemented by at least block 414 of FIG. 4 and block 606 of FIG. 6. In some examples, the engagement determining circuitry 206 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the engagement determining circuitry 206 may be instantiated by any other combination of hardware, software, and/or firmware. For example, the engagement determining circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example notification generating circuitry 208 to generate a flag or notification indicating an attendee 108, 110, 112 has switched from being present to absent (or vice versa) in response to a determination of such by the presence determining circuitry 204. For example, the example notification generating circuitry 208 may generate an “away” flag in response to the attendee becoming absent and an “awake” or “returned” flag in response to the attendee becoming present again. Additionally or alternatively, in some examples, the notification generating circuitry 208 generates a flag or notification indicating the level of engagement of an attendee 108, 110, 112 as determined by the engagement determining circuitry 206. In some examples, the notification generating circuitry 208 generates a single flag or notification that indicates both the presence or absence of the attendee 108, 110, 112 and the level of engagement of the attendee 108, 110, 112.

In some examples, the notification generating circuitry 208 causes the generated flag(s) or notification(s) to be transmitted (e.g., via the communications circuitry 202) to the conference server 124. In some examples, the conference server 124 may forward the flag(s) or notification(s) to the other client devices 102, 104, 106. In some examples, the conference server 124 may transmit some but not all information contained in and/or indicated by the flag(s) or notification(s). In some examples, information shared by the conferencing server is 124 is limited to preserve privacy. In some examples, the conference server 124 may pass on no information from the flag(s) or notification(s) to the other client devices 102, 104, 106. In examples where the client devices 102, 104, 106 are connected peer-to-peer, the flag(s) or notification(s) can be transmitted directly between the client devices 102, 104, 106. In some examples, the flag(s) or notification(s) (or associated information indicated by such) from a first client device 102, 104, 106 are shared with other client devices 102, 104, 106 to enable the other client devices 102, 104, 106 to adjust their operations based on the status (e.g., presence or absence and level of engagement) of the attendee associated with the first client device 102, 104, 106, as discussed further below. In some examples, the flag(s) or notification(s) are not directly shared with the other client devices 102, 104, 106 and, instead, a command is provided to the other client devices 102, 104, 106 from the conference server 124 that causes the other client devices 102, 104, 106 to adjust their operation. In some such examples, the command is based on the flag(s) or notification(s) provided to the conference server 124 from the first client device 102, 104, 106.

In some examples, the notification generating circuitry 208 generates the flag(s) or notifications(s) a threshold period of time after the presence determining circuitry 204 determines a change in the presence of the local attendee (e.g., from present to absent or from absent to present) and/or after the engagement determining circuitry 204 determines a change in the level of engagement of the local attendee. Additionally or alternatively, in some examples, the notification generating circuitry 208 causes the flag(s) or notification(s) to be transmitted a threshold period of time after being generated. In other examples, the notification generating circuitry 208 generates and/or causes the transmission of the flag(s) or notification(s) directly following a determination in a change in the presence of the local attendee and/or a change in the level of engagement of the local attendee.

In some examples, when the local attendee 108, 110, 112 is absent such that there is no need to provide a video stream, the notification generating circuitry 208 generates and/or defines alternate visual content to include in place of the video stream. The alternate visual content can be any suitable content such as a photo or other still image, a logo, an animated image, an avatar of the attendee, etc. In some examples, when the absent attendee is still engaged in the audio of the call and capable of speaking into a microphone 120, the avatar may be animated to move a mouth in a manner that matches the speech of the absent attendee. In some examples, the alternate visual content is stored and retrieved from the example memory 216. In some examples, the notification generating circuitry 208 defines the alternate visual content that is stored by and/or provided by the conference server 124. In some examples, as discussed further below, the conference server 124 determines, generates, and/or provides the alternate visual content without input from the client device 102, 104, 106. That is, in some examples, the notification generating circuitry 208 does not provide any information relating to alternate visual content.

In some examples, the notification generating circuitry 208 is instantiated by programmable circuitry executing notification generating instructions and/or configured to perform operations such as those represented by the flowchart(s) of FIGS. 4-6.

In some examples, the conference control circuitry 126 includes means for generating a notification. For example, the means for generating may be implemented by notification generating circuitry 208. In some examples, the notification generating circuitry 208 may be instantiated by programmable circuitry such as the example programmable circuitry 812 of FIG. 8. For instance, the notification generating circuitry 208 may be instantiated by the example microprocessor 1000 of FIG. 10 executing machine executable instructions such as those implemented by at least block 412 of FIG. 4 and blocks 604, 608, 614, 622 of FIG. 6. In some examples, the notification generating circuitry 208 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the notification generating circuitry 208 may be instantiated by any other combination of hardware, software, and/or firmware. For example, the notification generating circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example remote attendee analysis circuitry 210 to determine the status (e.g., presence or absence and level of engagement) of remote attendees. In some examples, this determination is made based on flag(s) or notification(s) generated by the notification generating circuitry 208 of the remote client devices 102, 104, 106 associated with the remote attendees. That is, each client device 102, 104, 106 monitors the presence or absence of the associated local attendee 108, 110, 112 (e.g., each attendee is considered local to the corresponding client device and remote from all other client devices) and generates notifications that may then be shared across the network (e.g., with one another and/or with the conference server 124). When a given client device 102, 104, 106 receives the notification and/or information (e.g., a command to adjust operations) based on the notification from another (remote) client device 102, 104, 106, the remote attendee analysis circuitry 210 parses the notification and/or associated information and/or command to determine whether the attendee of the associated remote client device 102, 104, 106 is present or absent and/or determines changes to operations based on the presence or absence of the remote attendee. In the same way, the example remote attendee analysis circuitry 210 of a given client device 102, 104, 106 determines the level of engagement of the remote attendee at the remote client device that initially generated and shared the notification and/or determines operation adjustments to be made based on the level of engagement.

In some examples, the remote attendee analysis circuitry 210 is instantiated by programmable circuitry executing remote attendee analysis instructions and/or configured to perform operations such as those represented by the flowchart(s) of FIGS. 4-6.

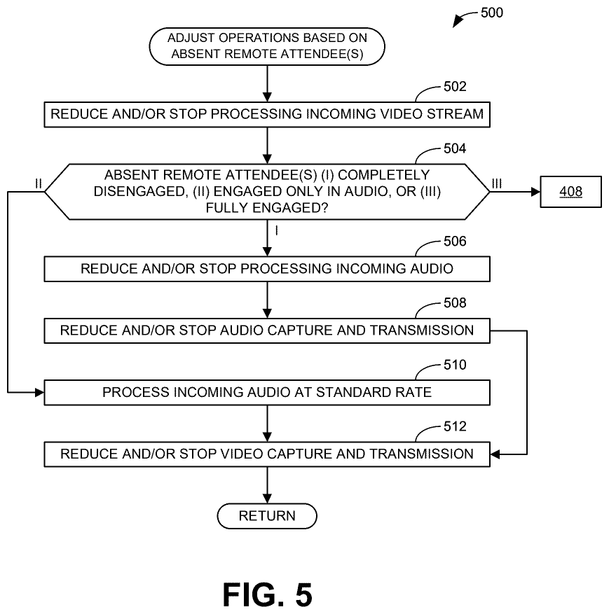

In some examples, the conference control circuitry 126 includes means for determining a status (e.g., presence, absence, and/or level of engagement) of remote attendees. For example, the means for determining may be implemented by remote attendee analysis circuitry 210. In some examples, the remote attendee analysis circuitry 210 may be instantiated by programmable circuitry such as the example programmable circuitry 812 of FIG. 8. For instance, the remote attendee analysis circuitry 210 may be instantiated by the example microprocessor 1000 of FIG. 10 executing machine executable instructions such as those implemented by at least blocks 404, 420 of FIG. 4 and block 504 of FIG. 5. In some examples, the remote attendee analysis circuitry 210 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the remote attendee analysis circuitry 210 may be instantiated by any other combination of hardware, software, and/or firmware. For example, the remote attendee analysis circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example local media processing circuitry 212 to determine how (and whether) to capture and process audio and/or video local to the associated client device 102, 104, 106. That is, the example local media processing circuitry 212 determines how/whether to capture video via the associated camera 114 of the client device 102, 104, 106 and how/whether to capture audio via the associated microphone 116. More particularly, in some examples, if the presence determining circuitry 204 determines that a local attendee is absent from the associated local client device (as in the case of the second and third attendees 110, 112), there is no one to be captured by the associated camera 114. Accordingly, in some such examples, the local media processing circuitry 212 stops (e.g., pauses) and/or reduces (e.g., lowers the frame rate of) the capturing of video for the conference call and/or stops and/or reduces the transmission (including any pre-processing of the video (e.g., encoding) for the transmission) of the captured video (if at least some video at some frame rate is captured). In this manner, computational resources are saved, power consumption is reduced (based on fewer computations as well as the reduced usage of the camera 114), and/or less bandwidth is used. On the other hand, if the presence determining circuitry 204 determines that a local attendee is present at the associated local client device (as in the case of the first attendee 108), the local media processing circuitry 212 causes video to be captured and transmitted at a standard rate. As used herein in this context, the “standard rate” is the default rate (e.g., frame rate) for capturing video for a video conference call (e.g., the full frame rate capability of the camera 114, the frame rate set by an associated conference call application, etc.).

Further, in some examples, the local media processing circuitry 212 also stops (e.g., pauses) and/or reduces (e.g., lowers the data rate of) the capture and/or transmission of audio data when a local attendee is absent. However, as discussed above, attendees may still be engaged in a call even though they are absent from the field of view 130 of an associated camera 114. Accordingly, in some examples, whether the capture and/or transmission of audio data is stopped and/or reduced depends on the level of engagement of the attendee as determined by the engagement determining circuitry 206. More particularly, in some examples, if the local attendee is completely disengaged, the local media processing circuitry 212 also stops (e.g., pauses) and/or reduces (e.g., lowers the data rate of) the capture and/or transmission of audio data. By contrast, if the local attendee is fully engaged or at least engaged in the audio of a conference call, the local media processing circuitry 212 causes audio to be captured and transmitted at a standard rate. As used herein in this context, the “standard rate” is the default rate (e.g., data rate) for capturing audio for a video conference call (e.g., the full data rate capability of the microphone 116, the data rate set by an associated conference call application, etc.).

In addition to determining how and/or whether to capture audio and/or video of a local attendee 108, 110, 112 based on the presence, absence, and/or level of engagement of the attendee 108, 110, 112, in some examples, the local media processing circuitry 212 determines how and/or whether to capture audio and/or video based on the presence, absence, and/or level of engagement of other (remote) attendees 108, 110, 112 at remote client devices 102, 104, 106 connected to a conference call. For instance, if there is a conference call between a local attendee and one remote attendee and the remote attendee is absent, there may not be any need to capture and/or transmit audio and video of the local attendee (even if the local attendee is present) because the remote attendee is not available to perceive it. However, this can depend on the level of engagement of the absent remote attendee. If the remote attendee is completely disengaged, the example local media processing circuitry 212 can stop and/or reduce the capture and/or transmission of both audio and video. If the remote attendee is engaged in the audio of the conference call but not the video, the example local media processing circuitry 212 can stop and/or reduce the capture and/or transmission of video while still capturing and transmitting the audio at the standard rate. Further, if the remote attendee is fully engaged in the conference call, the example local media processing circuitry 212 causes the capture and/or transmission of both audio and video at the standard rate. Thus, local client devices not only operate efficiently based on the presence or absence of a local attendee but can also improve efficiency based on the presence or absence of remote attendees, thereby improving efficiency (less computations, lower power consumption, less bandwidth usage) across an entire system of devices connected in a conference call.

The foregoing example assumes only two participants are on a conference call. If there are more than two participants, different operations may apply. For instance, if one remote attendee is absent but another remote attendee is present, there is still a need for the capture and transmission of both audio and video. While such audio and video may not be perceived by the absent attendee, it still needs to be provided to the other remote attendee that is present in the call. Stated generally, in some examples, regardless of the number of participants in a conference call, so long as at least one remote attendee is present (or at least fully engaged in the call), the example local media processing circuitry 212 causes the capture and/or transmission of both audio and video of the local attendee at the standard rate (assuming the local attendee is present).

In some examples, the local media processing circuitry 212 is instantiated by programmable circuitry executing local media processing instructions and/or configured to perform operations such as those represented by the flowchart(s) of FIGS. 4-6.

In some examples, the conference control circuitry 126 includes means for controlling the capture and/or transmission of media at a local client device. For example, the means for controlling may be implemented by local media processing circuitry 212. In some examples, the local media processing circuitry 212 may be instantiated by programmable circuitry such as the example programmable circuitry 812 of FIG. 8. For instance, the local media processing circuitry 212 may be instantiated by the example microprocessor 1000 of FIG. 10 executing machine executable instructions such as those implemented by at least block 408 of FIG. 4, blocks 508, 512 of FIG. 5, and blocks 602, 612, 618, 624 of FIG. 6. In some examples, the local media processing circuitry 212 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the local media processing circuitry 212 may be instantiated by any other combination of hardware, software, and/or firmware. For example, the local media processing circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 2, the conference control circuitry 126 includes the example incoming media processing circuitry 214 to determine how (and whether) to implement procedures to receive and process (e.g., decode) audio and/or video provided from a remote client device 102, 104, 106 for presentation at a local client device 102, 104, 106. In some examples, such determinations are based on the presence, absence, and/or level of engagement of a remote attendee 108, 110, 112 associated with the remote client device 102, 104, 106. For instance, in some examples, if the remote attendee is absent, there is no need to receive and/or process incoming video data from associated remote client devices at the standard rate because the video data will not include the attendee. Furthermore, in some examples, the video data may have been captured and/or transmitted at a reduced rate, in accordance with the discussion above. Further still, in some examples, the remote client device may not capture and/or transmit any video data such that there is no incoming data to be received or processed. In some examples, this scenario is only relevant to conference calls in which there are only two participants and/or where the participants communicate directly via peer-to-peer connections without an intermediate conference server 124. However, in examples that include a conference server 124 with more than two participants, the conference server 124 may receive the audio and/or video from each client device and combine the content into a composite signal that is transmitted to each client device. In some such examples, each client device may need to process the composite signal regardless of whether a particular remote attendee is absent.

In some examples, the incoming media processing circuitry 214 is instantiated by programmable circuitry executing incoming media processing instructions and/or configured to perform operations such as those represented by the flowchart(s) of FIGS. 4-6.

In some examples, the conference control circuitry 126 includes means for controlling the reception and processing of incoming media from remote client device. For example, the means for controlling may be implemented by incoming media processing circuitry 214. In some examples, the incoming media processing circuitry 214 may be instantiated by programmable circuitry such as the example programmable circuitry 812 of FIG. 8. For instance, the incoming media processing circuitry 214 may be instantiated by the example microprocessor 1000 of FIG. 10 executing machine executable instructions such as those implemented by at least blocks 416, 426 of FIG. 4, blocks 502, 506, 510 of FIG. 5, blocks 610, 616, 620, 622 of FIG. 6. In some examples, the incoming media processing circuitry 214 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the incoming media processing circuitry 214 may be instantiated by any other combination of hardware, software, and/or firmware. For example, the incoming media processing circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the conference control circuitry 126 of FIG. 1 is illustrated in FIG. 2, one or more of the elements, processes, and/or devices illustrated in FIG. 2 may be combined, divided, re-arranged, omitted, eliminated, and/or implemented in any other way. Further, the example communications circuitry 202, the example presence determining circuitry 204, the example engagement determining circuitry 206, the example notification generating circuitry 208, the example remote attendee analysis circuitry 210, the example local media processing circuitry 212, the example incoming media processing circuitry 214, the example memory 216, and/or, more generally, the example conference control circuitry 126 of FIG. 2, may be implemented by hardware alone or by hardware in combination with software and/or firmware. Thus, for example, any of the example communications circuitry 202, the example presence determining circuitry 204, the example engagement determining circuitry 206, the example notification generating circuitry 208, the example remote attendee analysis circuitry 210, the example local media processing circuitry 212, the example incoming media processing circuitry 214, the example memory 216, and/or, more generally, the example conference control circuitry 126, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example conference control circuitry 126 of FIG. 2 may include one or more elements, processes, and/or devices in addition to, or instead of, those illustrated in FIG. 2, and/or may include more than one of any or all of the illustrated elements, processes and devices.

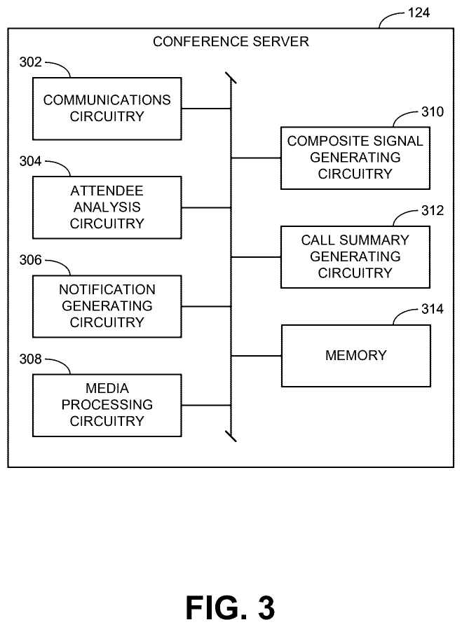

FIG. 3 is a block diagram of an example implementation of the conference server 124 of FIG. 1 to facilitate a conference call between different client devices 102, 104, 106. The conference server 124 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the conference server 124 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example conference server 124 includes example communications circuitry 302, example attendee analysis circuitry 304, example notification generating circuitry 306, example media processing circuitry 308, example composite signal generating circuitry 310, example call summary generating circuitry 312, and example memory 314.

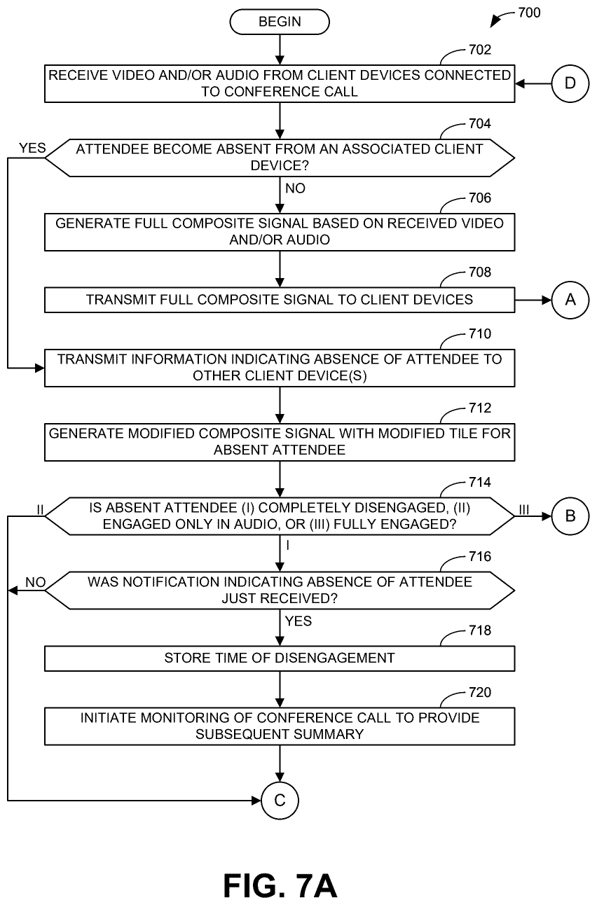

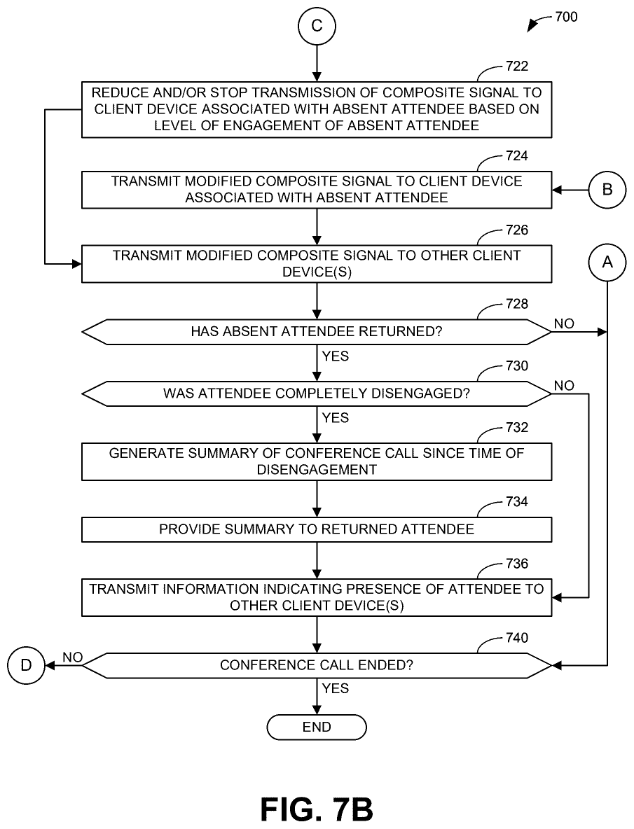

In the illustrated example of FIG. 3, the conference server 124 includes the example communications circuitry 302 to facilitate communications between the conference server 124 and client device 102, 104, 106. In some examples, the communications circuitry 302 is instantiated by programmable circuitry executing communications instructions and/or configured to perform operations such as those represented by the flowchart of FIGS. 7A and 7B.

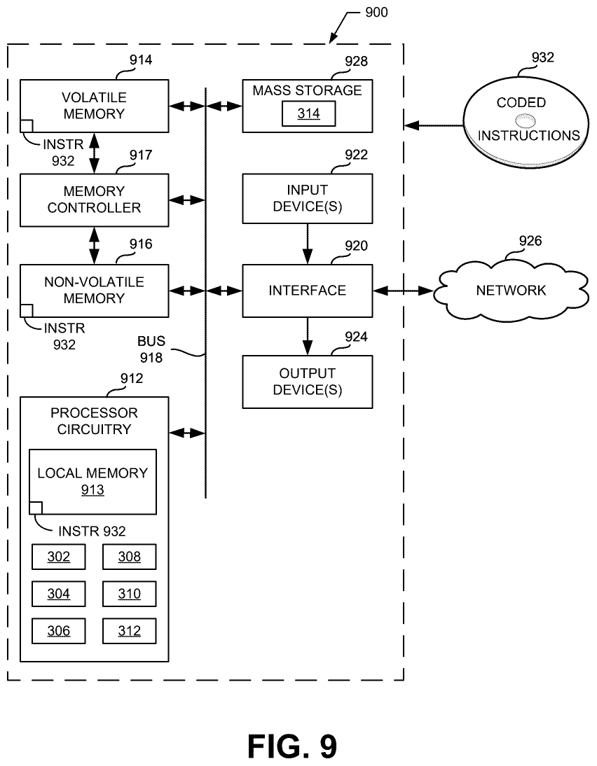

In some examples, the conference server 124 includes means for communicating. For example, the means for communicating may be implemented by communications circuitry 302. In some examples, the communications circuitry 302 may be instantiated by programmable circuitry such as the example programmable circuitry 912 of FIG. 9. For instance, the communications circuitry 302 may be instantiated by the example microprocessor 1000 of FIG. 10 executing machine executable instructions such as those implemented by at least blocks 708, 710, 724, 734 of FIGS. 7A and 7B. In some examples, the communications circuitry 302 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the communications circuitry 302 may be instantiated by any other combination of hardware, software, and/or firmware. For example, the communications circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 3, the conference server 124 includes the example attendee analysis circuitry 304 to determine the status (e.g., presence or absence and level of engagement) of attendees 108, 110, 112 at each of the client devices 102, 104, 106 connected to the conference call. In some examples, the attendee analysis circuitry 304 functions in a similar manner to the example remote attendee analysis circuitry 210 discussed above in connection with FIG. 2. As such, in some examples, the description of the example remote attendee analysis circuitry 210 provided above can be applied and/or suitably adapted for implementation by the example attendee analysis circuitry 304 of FIG. 3. More particularly, in some examples, the attendee analysis circuitry 304 determines the status (e.g., presence or absence and level of engagement) of attendees 108, 110, 112 based on flag(s) or notification(s) generated and provided by the notification generating circuitry 208 of the remote client devices 102, 104, 106 associated with the remote attendees. When the conference server 124 receives a flag or notification from a client device 102, 104, 106, the attendee analysis circuitry 304 parses the notification to determine whether the attendee of the associated remote client device 102, 104, 106 is present or absent. In the same way, the example attendee analysis circuitry 304 determines the level of engagement of the remote attendee at the remote client device that initially generated and provided the notification(s).

In some examples, the attendee analysis circuitry 304 is instantiated by programmable circuitry executing attendee analysis instructions and/or configured to perform operations such as those represented by the flowchart of FIGS. 7A and 7B.

In some examples, the conference server 124 includes means for determining the presence, absence, and/or level of engagement of attendees of a conference call. For example, the means for determining may be implemented by attendee analysis circuitry 304. In some examples, the attendee analysis circuitry 304 may be instantiated by programmable circuitry such as the example programmable circuitry 912 of FIG. 9. For instance, the attendee analysis circuitry 304 may be instantiated by the example microprocessor 1000 of FIG. 10 executing machine executable instructions such as those implemented by at least blocks 704, 728, 730 of FIGS. 7A and 7B. In some examples, the attendee analysis circuitry 304 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the attendee analysis circuitry 304 may be instantiated by any other combination of hardware, software, and/or firmware. For example, the attendee analysis circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 3, the conference server 124 includes the example notification generating circuitry 306 to generate a flag or notification indicating an attendee 108, 110, 112 of a particular client device 102, 104, 106 has switched from being present to absent (or vice versa) and/or a flag or notification indicating the level of engagement of an absent attendee. In some examples, such flag(s) or notification(s) are provided to other client devices 102, 104, 106 (e.g., other than the client device associated with the attendee the flag(s) or notification(s) are about). In some examples, the flag(s) or notification(s) generated by the notification generating circuitry 306 include and/or are based on information contained in flag(s) and/or notification(s) received (by the communications circuitry 302) from the client devices 102, 104, 106 (e.g., generated by the notification generating circuitry 208 of FIG. 2). In some examples, the flag(s) or notification(s) provided by the conference control circuitry 126 to the client devices 102, 104, 106 correspond to the flag(s) and/or notification(s) received from the client devices 102, 104, 106. In some such examples, the flag(s) or notification(s) are merely passed through the conference control circuitry 126 between client devices. In some such examples, the notification generating circuitry 306 is omitted. In other examples, to preserve privacy, the notification generating circuitry 306 used the notifications received from the client devices 102, 104, 106 to generate new (e.g., different) notifications passed on to other client devices 102, 104, 106. In some examples, the flag(s) or notification(s) generated by the notification generating circuitry 306 include and/or correspond to a command to the recipient client device(s) 102, 104, 106 to adjust operations based on the status of attendees 108, 110, 112 at other ones of the client devices 102, 104, 106.

In some examples, the conference server 124 does not forward any information about the status of attendees 108, 110, 112. In some such examples, the notification generating circuitry 306 is omitted. In some examples, the notification generating circuitry 306 functions in a similar manner to the example notification generating circuitry 208 discussed above in connection with FIG. 2. As such, in some examples, the description of the example notification generating circuitry 208 provided above can be applied and/or suitably adapted for implementation by the example notification generating circuitry 306 of FIG. 3.

In some examples, the notification generating circuitry 306 is instantiated by programmable circuitry executing notification generating instructions and/or configured to perform operations such as those represented by the flowchart of FIGS. 7A and 7B.

In some examples, the conference server 124 includes means for generating a notification. For example, the means for generating may be implemented by notification generating circuitry 306. In some examples, the notification generating circuitry 306 may be instantiated by programmable circuitry such as the example programmable circuitry 912 of FIG. 9. For instance, the notification generating circuitry 306 may be instantiated by the example microprocessor 1000 of FIG. 10 executing machine executable instructions such as those implemented by at least blocks 710, 736 of FIGS. 7A and 7B. In some examples, the notification generating circuitry 306 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the notification generating circuitry 306 may be instantiated by any other combination of hardware, software, and/or firmware. For example, the notification generating circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 3, the conference server 124 includes the example media processing circuitry 308 to determine how to process incoming media (audio and/or video content) received from the different client devices 102, 104, 106 connected to a conference call and how to prepare and/or transmit the media back to the client devices 102, 104, 106. In some examples, the media processing circuitry 308 functions in a similar manner to aspects of the example local media processing circuitry 212 and/or the example incoming media processing circuitry 214 discussed above in connection with FIG. 2. As such, in some examples, the description of the example local media processing circuitry 212 and/or the example incoming media processing circuitry 214 provided above can be applied and/or suitably adapted for implementation by the example media processing circuitry 308 of FIG. 3. More particularly, in some examples, media processing circuitry 308 determine the frame rate (for video) and/or the data rate (for audio) at which media received from different client devices 102, 104, 106 is processed and/or transmitted to other client devices 102, 104, 106 based on the presence, absence, and/or level of engagement of attendees 108, 110, 112 associated with the client devices 102, 104, 106. In some examples, the media processing circuitry 308 determines when to stop processing and/or transmitting conference call media to a given client device 102, 104, 106 based on the presence, absence, and/or level of engagement of the attendee 108, 110, 112 associated with the given client device 102, 104, 106.

In some examples, the media processing circuitry 308 is instantiated by programmable circuitry executing media processing instructions and/or configured to perform operations such as those represented by the flowchart of FIGS. 7A and 7B.

In some examples, the conference server 124 includes means for controlling the processing and transmission of media to and from client devices connected in a conference call. For example, the means for controlling may be implemented by media processing circuitry 308. In some examples, the media processing circuitry 308 may be instantiated by programmable circuitry such as the example programmable circuitry 912 of FIG. 9. For instance, the media processing circuitry 308 may be instantiated by the example microprocessor 1000 of FIG. 10 executing machine executable instructions such as those implemented by at least block 722 of FIGS. 7A and 7B. In some examples, the media processing circuitry 308 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the media processing circuitry 308 may be instantiated by any other combination of hardware, software, and/or firmware. For example, the media processing circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 3, the conference server 124 includes the example composite signal generating circuitry 310 to generate a composite signal to be provided to the various client devices 102, 104, 106 connected to a conference call. In some examples, the composite signal is a combination of the video and/or audio received from each client device 102, 104, 106. In some examples, the composite signal includes multiple different tiles corresponding to respective ones of the multiple different client devices 102, 104, 106. Sending a composite signal with content associated with different tiles enables each client device 102, 104, 106 to populate a corresponding tile on the respective display screen 118 within which an associated attendee can see the video stream captured by the camera 114 of each remote client device 102, 104, 106 (and, in some cases, the video stream captured by the camera 114 of the local client device as well).

In some examples, the content included in the composite signal and/or how the content is combined is based on the determinations of the media processing circuitry 308 and/or the attendee analysis circuitry 304 discussed above. More particularly, in some examples, when all attendees 108, 110, 112 are present at their respective client devices 102, 104, 106, the composite signal generating circuitry 310 generates a full composite signal based on the audio and video received from each client device 102, 104, 106. However, if an attendee 108, 110, 112 is absent, there is no need to provide the video stream from the associated client device 102, 104, 106 because there is nothing meaningful to show in the video being captured by the associated camera 114. Indeed, in some examples, as discussed above, the client device 102, 104, 106 may stop sending the video stream when the attendee is absent. Thus, in some examples where an attendee is absent, the composite signal generating circuitry 310 generates a modified composite signal in which alternate visual content is included in the tile associated with the absent attendee. In some examples, the alternate visual content serves as an indication that the associated attendee is absent. In some examples, the alternate visual content is defined by and/or provided in the flag or notification from the client device 102, 104, 106 of the absent attendee 108, 110, 112 that initially reported the absence of the attendee. In some examples, the alternate visual content is defined by, generated by, and/or retrieved from the memory 314 by the composite signal generating circuitry 310. As discussed above, the alternate visual content can be any suitable content such as a photo or other still image, a logo, an animated image, an avatar of the attendee, etc.

In some examples, different composite signals are generated and provided to different client devices 102, 104, 106 depending on the presence, absence, and/or level of engagement of the attendees 108, 110, 112 associated with the different client devices 102, 104, 106. For example, the modified composite signal described above may be sent to present attendees and/or attendees that are absent but still fully engaged in the conference call. However, an attendee that is engaged only in the audio, there is no need to send any video data. Accordingly, in some such examples, the audio portion of the composite signal (whether the full composite signal or the modified composite signal) is sent to such attendees without sending the video portion of the composite signal.

In some examples, the composite signal generating circuitry 310 is instantiated by programmable circuitry executing composite signal generating instructions and/or configured to perform operations such as those represented by the flowchart of FIGS. 7A and 7B.

In some examples, the conference server 124 includes means for generating a composite signal for a conference call. For example, the means for generating may be implemented by composite signal generating circuitry 310. In some examples, the composite signal generating circuitry 310 may be instantiated by programmable circuitry such as the example programmable circuitry 912 of FIG. 9. For instance, the composite signal generating circuitry 310 may be instantiated by the example microprocessor 1000 of FIG. 10 executing machine executable instructions such as those implemented by at least blocks 706, 712, 714, 716 of FIGS. 7A and 7B. In some examples, the composite signal generating circuitry 310 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the composite signal generating circuitry 310 may be instantiated by any other combination of hardware, software, and/or firmware. For example, the composite signal generating circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 3, the conference server 124 includes the example call summary generating circuitry 312 to generate summaries of conference calls. In some examples, the call summary generating circuitry 312 generates summaries for portions of a conference call during which an attendee was absent and/or disengaged from the call. That is, in some examples, the call summary generating circuitry 312 begins monitoring a conference call to identify highlights and/or to generate a summary in response to an indication of an attendee leaving (e.g., becoming absent from) a conference call who is also disengaged. Additionally or alternatively, in some examples, the call summary generating circuitry 312 constantly monitors a conference call regardless of the presence of absence the attendees. In some such examples, the call summary generating circuitry 312 stores a time when an attendee becomes absent and disengaged from the call to identify the portion(s) of the conference call that need to be summarized for the attendee. In some examples, the call summary generating circuitry 312 generates and provides a summary to the attendee in response to the attendee returning to the conference call (e.g., re-engaging with the call and/or returning to be present at an associated client device). In some examples, the call summary generating circuitry 312 provides the summary during an ongoing conference call. In other examples, the call summary generating circuitry 312 provides the summary to the attendee after the conference call ends. In some examples, instead of generating a summary that identifies highlights, the call summary generating circuitry 312 can provide a transcript of the conference call with flags identifying the portions that were missed by an attendee due to being absent and/or disengaged from the call. In some examples, only the portions of the transcript that were missed are provided by the call summary generating circuitry 312. In some examples, the call summary generating circuitry 312 provides links to video recordings of the relevant portion(s) of the conference call missed by an attendee.

In some examples, the call summary generating circuitry 312 is instantiated by programmable circuitry executing call summary generating instructions and/or configured to perform operations such as those represented by the flowchart of FIGS. 7A and 7B.

In some examples, the conference server 124 includes means for generating a summary of a conference call. For example, the means for generating may be implemented by call summary generating circuitry 312. In some examples, the call summary generating circuitry 312 may be instantiated by programmable circuitry such as the example programmable circuitry 912 of FIG. 9. For instance, the call summary generating circuitry 312 may be instantiated by the example microprocessor 1000 of FIG. 10 executing machine executable instructions such as those implemented by at least block 732 of FIGS. 7A and 7B. In some examples, the call summary generating circuitry 312 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the call summary generating circuitry 312 may be instantiated by any other combination of hardware, software, and/or firmware. For example, the call summary generating circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the conference server 124 of FIG. 1 is illustrated in FIG. 3, one or more of the elements, processes, and/or devices illustrated in FIG. 3 may be combined, divided, re-arranged, omitted, eliminated, and/or implemented in any other way. Further, the example communications circuitry 302, the example attendee analysis circuitry 304, the example notification generating circuitry 306, the example media processing circuitry 308, the example composite signal generating circuitry 310, the example call summary generating circuitry 312, the example memory 314, and/or, more generally, the example conference server 124 of FIG. 3, may be implemented by hardware alone or by hardware in combination with software and/or firmware. Thus, for example, any of the example communications circuitry 302, the example attendee analysis circuitry 304, the example notification generating circuitry 306, the example media processing circuitry 308, the example composite signal generating circuitry 310, the example call summary generating circuitry 312, the example memory 314, and/or, more generally, the example conference server 124, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example conference server 124 of FIG. 3 may include one or more elements, processes, and/or devices in addition to, or instead of, those illustrated in FIG. 3, and/or may include more than one of any or all of the illustrated elements, processes and devices.

FIGS. 4-6 are flowcharts representative of example machine readable instructions, which may be executed by programmable circuitry to implement and/or instantiate the conference control circuitry 126 of FIG. 2 and/or representative of example operations which may be performed by programmable circuitry to implement and/or instantiate the conference control circuitry 126 of FIG. 2. FIGS. 7A and 7B is a flowchart representative of example machine readable instructions, which may be executed by programmable circuitry to implement and/or instantiate the conference server 124 of FIG. 3 and/or representative of example operations which may be performed by programmable circuitry to implement and/or instantiate the conference server 124 of FIG. 3. The machine readable instructions may be one or more executable programs or portion(s) of one or more executable programs for execution by programmable circuitry such as the programmable circuitry 812, 912 shown in the example processor platform 800, 900 discussed below in connection with FIGS. 8 and/or 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example programs are described with reference to the flowchart(s) illustrated in FIGS. 4-7B, many other methods of implementing the example conference control circuitry 126 and/or the conference server 124 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to implement the example conference control circuitry 126 of FIG. 2. The example machine-readable instructions and/or the example operations 400 of FIG. 4 begin at block 402 where the example presence determining circuitry 204 determines whether a local attendee 108, 110, 112 is present at an associated client device 102, 104, 106 connected to a conference call. As discussed above, each attendee is considered the local attendee with respect to the associated (e.g., local) client device through which the attendee joined the conference call while the other attendees are referred to herein as remote attendees that join the conference call via corresponding remote client devices. In the context of FIG. 4, the local client device is the client device including the conference control circuitry 126 that is implementing the operations 400 of FIG. 4. Thus, the local attendee is the attendee associated with that client device. For the purposes of explanation of the flowchart of FIG. 4, the first client device 102 will be treated as the local client device and the first attendee 108 will be treated as the local attendee. However, either of the other client devices 104, 106 could also implement the operations of FIG. 4 and, thus, be considered as the local client device. If, at block 402, the example presence determining circuitry 204 determines that the local attendee 108 is not present (e.g., is absent), control advances to block 404. Otherwise, control advances to block 420.

At block 404, the example remote attendee analysis circuitry 210 determines whether at least one remote attendee (e.g., the second or third attendee 110, 112 of FIG. 1) is present in the conference call. In some examples, the remote attendee analysis circuitry 210 makes this determination based on whether any of the remote client devices (e.g., the second or third client devices 104, 106 of FIG. 1) have provided information (either directly or through the conference server 124) indicating the attendee is absent. Whether or not there are any remote attendees present affects whether there is any meaningful visual content to be presented at the local client device 102. That is, if all remote attendees 110, 112 are absent, none of them are captured by the cameras 114 on the associated client devices 104, 106. As a result, there is no need for the local client device 102 to receive, process, and/or present video streams from the remote client devices 104, 106. This creates the possibility for adjustments to the local client device to save power by reducing computational processing associated with incoming media without affecting user experience. By contrast, so long as there is at least one remote attendee who is present, there is likely meaningful incoming media to be processed. Accordingly, in some examples, the conference control circuitry 126 adjust operations in different ways depending on the determination made at block 404. Specifically, if no attendees are present, control advances to block 406 where the example conference control circuitry 126 adjusts operations based on the absent remote attendee(s). Further detail regarding the implementation of block 406 is provided below in connection with FIG. 5. If at least one remote attendee is present, control advances to block 408 where the example conference control circuitry 126 adjusts operations based on the absent local attendee. Further detail regarding the implementation of block 408 is provided below in connection with FIG. 6.

After the implementation of either block 406 or block 408, control advances to block 410. At block 410, the example presence determining circuitry 204 determines whether the local attendee 108 is detected at the local client device again (e.g., is present). If so, control advances to block 412 where the example notification generating circuitry 208 (in combination with the example communications circuitry 202) provides a notification indicating the local attendee 108 is present at the local client device 102. Thereafter, control advances to block 414. If the local attendee has not been detected again at the local client device (block 410), control advances to block 418.

At block 414, the example engagement determining circuitry 206 determines whether the local attendee 108 was completely disengaged while absent (e.g., before the attendee returned). If so, control advances to block 416 where the example incoming media processing circuitry 214 provides a summary of content missed by the local attendee. In some examples, the summary is provided by the conference server 124 in response to receiving the notification provided at block 412. Thereafter, control advances to block 418 where the example communications circuitry 202 determines whether the conference call has ended. If so, the example process of FIG. 4 ends. Otherwise, control returns to block 402. In some examples, the summary (provided at block 416) is not provided until after the conference call is ended. In other examples, block 416 is omitted. Returning to block 414, if the example engagement determining circuitry 206 determines the local attendee was not completely disengaged, the attendee would not have missed anything from the conference call such that there is no need for the attendee to be provided with a summary. Accordingly, in this example, control advances directly to block 418 to determine whether the conference call has ended.

As noted above, if the example presence determining circuitry 204 determines (at block 402) that the local attendee 108 is present at the local client device 102, control advances to block 420. At block 420, the example remote attendee analysis circuitry 210 determines whether at least one remote attendee is present in the conference call. In some examples, this determination is similar to the determination made at block 404 as described above. If no attendees are present, control advances to block 422 where the example conference control circuitry 126 adjusts operations based on the absent remote attendee(s). This is similar to block 406. As with block 406, further detail regarding the implementation of block 422 is provided below in connection with FIG. 5. After the implementation of block 422, control advances to block 418. If at least one remote attendee is present (determined at block 420, control advances to block 424 where the example local media processing circuitry 212 (in combination with the example communications circuitry) captures and transmits audio and video at a standard rate. Further, at block 426, the example incoming media processing circuitry 214 processes incoming audio and video at a standard rate. Thereafter, control advances to block 418 to either continue or end the conference call.

FIG. 5 is a flowchart representative of example machine readable instructions and/or example operations 500 that may be executed, instantiated, and/or performed by programmable circuitry to implement block 406 and/or block 422 of FIG. 4. The example machine-readable instructions and/or the example operations 500 of FIG. 5 begin at block 502 where the example incoming media processing circuitry 214 reduces and/or stops processing the incoming video stream. As discussed above, this scenario occurs when no remote attendees are present and so there is no meaningful video content to process. In some examples, the remote client devices may reduce and/or stop the capturing and/or transmission of video such that there is no incoming video stream to process. In some such examples, block 502 is omitted or skipped.

At block 504, the example remote attendee analysis circuitry 210 determines whether the absent remote attendee(s) are (I) completely disengaged with the conference call, (II) engaged only in audio (e.g., engaged in the audio but not the video such as when they are away from the display screen 118 but have a headset to listen and/or speak in the call), or (III) fully engaged in the conference call (e.g., when the attendee is out of the field of view 130 of the camera 114 but still able to view the display screen 118 and hear audio from the speaker(s) 120). If the remote attendee(s) are completely disengaged (option I), none of the remote attendees will be able to provide audio inputs to the conference call and none will be able to see video or hear audio provided from the local client device 102. As such, there is no need for the local client device 102 to process incoming audio and no need to collect or transmit audio or video of the local attendee 108. Accordingly, at block 506, the example incoming media processing circuitry 214 reduces and/or stops processing incoming audio. Further, at block 508, the example local media processing circuitry 212 reduces and/or stops audio capture and/or transmission. Thereafter, control advances to block 512.

Returning to block 504, if the example remote attendee analysis circuitry 210 determines that at least one absent remote attendee is partially engaged in the conference call (option II), the remote attendee will still be able to speak and provide audio to the call and be able to hear audio from the local attendee. Accordingly, in this scenario, block 506 and block 508 are skipped and control advances to block 510 where the example incoming media processing circuitry 214 processes incoming audio at a standard rate. Control then advances to block 512.

At block 512, which is arrived at through either option I or option II of block 504, the example local media processing circuitry 212 reduces and/or stops video capture and/or transmission. Thereafter, the example process of FIG. 5 ends and returns to complete the process of FIG. 4.

If the example remote attendee analysis circuitry 210 determines (at block 504) that at least one absent remote attendee is fully engaged in the conference call (option III), then the local client device 102 should continue to provide both audio and video to be perceived by the remote attendee. In effect, the remote attendee is treated as if still present at the associated remote client device as far as the operations of the local client device 102 are concerned. Accordingly, in some examples, control advances to block 408 of FIG. 4 where the example conference control circuitry 126 adjusts operations based on the absent local attendee. As noted above, further detail regarding the implementation of block 408 is provided below in connection with FIG. 6.

FIG. 6 is a flowchart representative of example machine readable instructions and/or example operations 600 that may be executed, instantiated, and/or performed by programmable circuitry to implement block 408 of FIG. 4. The example machine-readable instructions and/or the example operations 600 of FIG. 6 begin at block 602 where the example local media processing circuitry 212 reduces and/or video capture and/or transmission. At block 604, the example notification generating circuitry 208 provides alternate visual content for a tile in the conference call associated with the absent local attendee. In some examples, the example notification generating circuitry 208 merely identifies or defines the alternate visual content to be provided by the conference server 124. In other examples, block 604 is omitted entirely.

At block 606, the example engagement determining circuitry 206 determines whether the local attendee 108 is (I) completely disengaged with the conference call, (II) engaged only in audio (e.g., engaged in the audio but not the video such as when the attendee is away from the display screen 118 but has a headset to listen and/or speak in the call), or (III) fully engaged in the conference call (e.g., when the attendee is out of the field of view 130 of the camera 114 but still able to view the display screen 118 and hear audio from the speaker(s) 120). If the local attendee is completely disengaged (option I), control advances to block 608 where the example notification generating circuitry 208 (in combination with the example communications circuitry 202) provides a notification indicating the local attendee 108 is completely disengaged. Inasmuch as the local attendee 108 is completely disengaged, the attendee will neither be providing audio nor able to hear the audio from other attendees. Accordingly, at block 610, the example incoming media processing circuitry 214 reduces and/or stops processing incoming audio. Further, at block 612, the example local media processing circuitry 212 reduces and/or stops audio capture and/or transmission. Thereafter, control advances to block 620 where the example incoming media processing circuitry 214 reduces and/or stops processing incoming video. Thereafter, the example program of FIG. 6 ends and returns to complete the process of FIG. 4.

Returning to block 606, if the example engagement determining circuitry 206 determines that the local attendee 108 is engaged only in the audio of the conference call (option II), control advances to block 614 where the example notification generating circuitry 208 (in combination with the example communications circuitry 202) provides a notification indicating the local attendee 108 is engaged in audio but not video. Inasmuch as the local attendee 108 is not engaged in video, there is no need for the local client device 102 to receive, process, and/or present video from other (remote) client devices 104, 106. However, inasmuch as the local attendee is at least engaged in the audio, there is still a need to capture and transmit audio from the local attendee and to receive, process, and provide audio from other (remote) attendees. Accordingly, at block 616, the example incoming media processing circuitry 214 processes incoming audio at a standard rate. Further, at block 618, the example local media processing circuitry 212 captures and transmits audio at a standard rate. Further still, at block 620, the example incoming media processing circuitry 214 reduces and/or stops processing incoming video. Thereafter, the example program of FIG. 6 ends and returns to complete the process of FIG. 4.

Returning to block 606, if the example engagement determining circuitry 206 determines that the local attendee 108 is fully engaged in the conference call (option III), control advances to block 622 where the example notification generating circuitry 208 (in combination with the example communications circuitry 202) provides a notification indicating the local attendee 108 is fully engaged in the conference call. Inasmuch as the local attendee 108 is fully engaged in the conference call (though absent from the field of view 130 of the camera 114), the local client device 102 should continue to receive, process, and present both audio and video to the local attendee 108, as well as continue to capture audio at the local client device 102. Accordingly, in some examples, at block 622, the example incoming media processing circuitry 214 processes incoming audio and video at a standard rate. Further, at block 624, the example local media processing circuitry 212 captures and transmits audio at a standard rate. Thereafter, the example program of FIG. 6 ends and returns to complete the process of FIG. 4.

FIGS. 7A and 7B is a flowchart representative of example machine readable instructions and/or example operations 700 that may be executed, instantiated, and/or performed by programmable circuitry to implement the example conference server 124 of FIG. 3. The example machine-readable instructions and/or the example operations 700 of FIG. 7 begin at block 702, where the example conference server 124 receives video and/or audio from client devices 102, 104, 106 connected to a conference call. At block 704, the example attendee analysis circuitry 304 determines whether an attendee 108, 110, 112 has become absent from an associated client device 102, 104, 106. In some examples, this determination is made based on receipt of a notification from the associated client device provided based on any one of blocks 608, 614, or 622 of FIG. 6. If no attendee is absent (e.g., all attendees are present), control advances to block 706. Otherwise, control advances to block 710.

At block 706, the example composite signal generating circuitry 310 generates a full composite signal based on the received video and/or audio. At block 708, the communications circuitry 302 transmits the full composite signal to the client devices 102, 104, 106. Thereafter, control advances to block 740 where the conference server 124 determines whether the conference call has ended. If so, the example program of FIGS. 7A and 7B ends. Otherwise, control returns to block 702.

At block 710, the example notification generating circuitry 306 (in combination with the example communications circuitry 302) transmits information indicating the absence of the attendee to other client device(s) 102, 104, 106. In some examples, this information does not explicitly indicate the absence of the attendee (e.g., due to privacy concerns). Rather, in some examples, the information is a command instructing the other client device(s) 102, 104, 106 to adjust their operation based on the absence of the attendee. In other examples, the conference server 124 does not send any information indicating the absence of the attendee. In some such examples, block 710 is omitted.

At block 712, the example composite signal generating circuitry 310 generates a modified composite signal with a modified tile for the absent attendee. In some examples, the modified tile for the absent attendee includes alternate visual content provided by the client device 102, 104, 106 of the absent attendee. In other examples, the composite signal generating circuitry 310 provides and/or generates the alternate visual content (and/or retrieves it from the example memory 314).

At block 714, the example attendee analysis circuitry 304 determines whether the absent attendee(s) are (I) completely disengaged with the conference call, (II) engaged only in audio (e.g., engaged in the audio but not the video such as when they are away from the display screen 118 but have a headset to listen to and/or speak in the call), or (III) fully engaged in the conference call (e.g., when the attendee is out of the field of view 130 of the camera 114 but still able to view the display screen 118 and hear audio from the speaker(s) 120). If the absent attendee(s) are completely disengaged (option I), control advances to block 716 where the example attendee analysis circuitry 304 determines whether the notification indicating the absence of the attendee was just received (e.g., whether the attendee recently went absent). If so, control advances to block 718 where the example call summary generating circuitry stores the time of the attendee's disengagement (e.g., in the example memory 314). Thereafter, at block 720, the example call summary generating circuitry initiates monitoring of the conference call to provide a subsequent summary. In some examples, the call summary generating circuitry is always monitoring the conference call such that block 720 is omitted and the time of disengagement (recorded at block 718) is used to select the relevant portion of the conference call to summarize later on. In other examples, block 718 is omitted and the particular portion of the conference call is based on when the monitoring of the call is initiated at block 720. Thereafter, control advances to block 722. If the example attendee analysis circuitry 304 determines (at block 716) that the notification indicating the absence of the attendee was not just received (e.g., it was received previously), control advances directly to block 722.

Returning to block 714, if the example attendee analysis circuitry 304 determines that the absent attendee is engaged only in the audio of the conference call (option II), control advances directly to block 722. At block 722, the example media processing circuitry 308 reduces and/or stops transmission of the composite signal to the client device 102, 104, 106 associated with the absent attendee based on the level of engagement of the absent attendee. That is, if the absent attendee is completely disengaged there is no need to provide either audio or video and so both can be stopped and/or reduced. By contrast, if the absent attendee is engaged in the audio but not the video, the example media processing circuitry 308 reduces and/or stops the transmission of the video but continues to transmit the audio at a standard rate. Thereafter, control advances to block 726.

Returning to block 714, if the example attendee analysis circuitry 304 determines that the absent attendee is fully engaged in the conference call (option III), control advances directly to block 724 where the example communications circuitry 302 transmits the modified composite signal to the client device 102, 104, 106 associated with the absent attendee. Thereafter, control advances to block 726 where the example transmits the modified composite signal to the other client device(s) 102, 104, 106.

At block 728, the example attendee analysis circuitry 304 determines whether the absent attendee has returned. If not, control advances to block 740 where the conference server 124 determines whether the conference call has ended. If so, the example program of FIGS. 7A and 7B ends. Otherwise, control returns to block 702. If the absent attendee has returned (as determined at block 728), control advances to block 730 where the example attendee analysis circuitry 304 determines whether the attendee was completely disengaged. If so, the example call summary generating circuitry 312 generates a summary of the conference call since the time of disengagement (e.g., as recorded at block 718). At block 734, the example communications circuitry 302 provides the summary to the returned attendee. Thereafter, control advances to block 736. Returning to block 730, if the absent attendee was not completely disengaged, control advances directly to block 736. In some examples, the summary is not provided to the absent attendee until after the end of the conference call.

At block 736, the example communications circuitry transmits information indicating the presence of the attendee to the other clients. Thereafter, control advances to block 740 where the conference server 124 determines whether the conference call has ended. If the conference call has not ended, control returns to block 702. Otherwise, the example program of FIGS. 7A and 7B ends.

FIG. 8 is a block diagram of an example programmable circuitry platform 800 structured to execute and/or instantiate the example machine-readable instructions and/or the example operations of FIGS. 4-6 to implement the conference control circuitry 126 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example communications circuitry 202, the example presence determining circuitry 204, the example engagement determining circuitry 206, the example notification generating circuitry 208, the example remote attendee analysis circuitry 210, the example local media processing circuitry 212, and the example incoming media processing circuitry 214.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 4-6, may be stored in the mass storage device 828, in the volatile memory 814, in the non-volatile memory 816, and/or on at least one non-transitory computer readable storage medium such as a CD or DVD which may be removable.

FIG. 9 is a block diagram of an example programmable circuitry platform 900 structured to execute and/or instantiate the example machine-readable instructions and/or the example operations of FIGS. 7A and 7B to implement the conference server 124 of FIG. 3. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example communications circuitry 302, the example attendee analysis circuitry 304, the example notification generating circuitry 306, the example media processing circuitry 308, the example composite signal generating circuitry 310, and the example call summary generating circuitry 312.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7A and 7B, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 812 of FIG. 8 and/or the programmable circuitry 912 of FIG. 9. In this example, the programmable circuitry 812 of FIG. 8 and/or the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 4-6 and/or 7A and 7B to effectively instantiate the circuitry of FIG. 2 as logic circuits to perform operations corresponding to those machine readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 4-6 and/or 7A and 7B.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 814, 816 of FIG. 8, the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 812 of FIG. 8 and/or the programmable circuitry 912 of FIG. 9. In this example, the programmable circuitry 812 and/or the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 4-6 and/or 7A and 7B but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6 and/or 7A and 7B. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6 and/or 7A and 7B. As such, the FPGA circuitry 1100 may be configured and/or structured to effectively instantiate some or all of the operations/functions corresponding to the machine readable instructions of the flowchart(s) of FIGS. 4-6 and/or 7A and 7B as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 4-6 and/or 7A and 7B faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 4-6 and/or 7A and 7B and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 812 of FIG. 8 and/or the programmable circuitry 912 of FIG. 9, many other approaches are contemplated. For example, FPGA circuitry may include an on-board CPU, such as one or more of the example CPU 1120 of FIG. 10. Therefore, the programmable circuitry 812 of FIG. 8 and/or the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 4-6 and/or 7A and 7B to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 4-6 and/or 7A and 7B, and/or an ASIC may be configured and/or structured to perform third operation(s)/function(s) corresponding to a third portion of the machine readable instructions represented by the flowcharts of FIGS. 4-6 and/or 7A and 7B.

It should be understood that some or all of the circuitry of FIGS. 2 and/or 3 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIGS. 2 and/or 3 may be implemented within one or more virtual machines and/or containers executing on the microprocessor 1000 of FIG. 10.

In some examples, the programmable circuitry 812 of FIG. 8 and/or the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 812 of FIG. 8 and/or the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

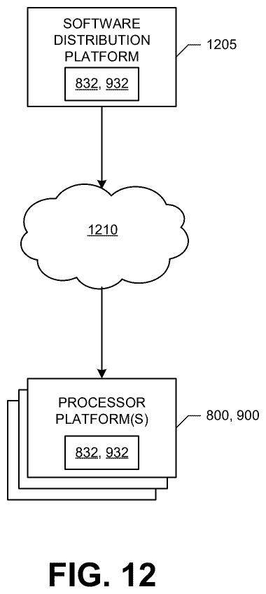

A block diagram illustrating an example software distribution platform 1205 to distribute software such as the example machine readable instructions 832 of FIG. 8 and/or the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 832 of FIG. 8 and/or the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 832 and/or the machine readable instructions 932, which may correspond to the example machine readable instructions of FIGS. 4-6 and/or 7A and 7B, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 and/or the machine readable instructions 932 from the software distribution platform 1205. For example, the software, which may correspond to the example machine readable instructions of FIG. 4-6, may be downloaded to the example programmable circuitry platform 800, which is to execute the machine readable instructions 832 to implement the conference control circuitry 126. Additionally or alternatively, in some examples, the software, which may correspond to the example machine readable instructions of FIGS. 7A and 7B, may be downloaded to the example programmable circuitry platform 900, which is to execute the machine readable instructions 832 to implement the conference server 124. In some examples, one or more servers of the software distribution platform 1205 periodically offer, transmit, and/or force updates to the software (e.g., the example machine readable instructions 832 of FIG. 8 and/or the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the monitoring of the presence, absence, and/or level of engagement of attendees to a conference call at any given client device used to connect to the conference call and the sharing of such information to achieve at least one of (i) a reduction in power consumption associated with a conference call relative or (ii) a reduction in network bandwidth usage associated with the conference call relative to before the first attendee went absent. The reduction in power can be based on reduced computational loads associated with the capturing and/or processing of media (both outgoing and incoming) and/or turning off microphones and/or cameras used to capture such media. The reduction in network bandwidth usage is based on less data being transmitted between client devices connected to the conference call. The efficiencies achieved in accordance with teachings disclosed herein are not limited to a local client device where an attendee becomes absent. Rather, multiple different (e.g., all) client devices connected to the conference call can be directed to adjust operations based on the change in status of any single attendee. Disclosed systems, apparatus, articles of manufacture, and methods are accordingly directed to one or more improvement(s) in the operation of a machine such as a computer or other electronic and/or mechanical device.

Further examples and combinations thereof include the following:
Example 1 includes an apparatus comprising interface circuitry, machine readable instructions, and at least one processor circuit to at least one of instantiate or execute the machine readable instructions to determine whether a first attendee of a conference call is absent from a first client device connected to the conference call, and in response to determining the first attendee is absent, cause transmission of a notification that indicates the first attendee is absent, the notification to cause a second client device connected to the conference call to achieve at least one of (i) a reduction in power consumption associated with the conference call relative to before the first attendee went absent or (ii) a reduction in network bandwidth usage associated with the conference call relative to before the first attendee went absent.
Example 2 includes the apparatus of example 1, wherein the first and second client devices are connected to the conference call via a server distinct from the first client device and distinct from the second client device, the notification transmitted to the server.
Example 3 includes the apparatus of example 2, wherein the notification is not transmitted to the second client device.
Example 4 includes the apparatus of any one of examples 1-3, wherein the conference call is implemented via a peer-to-peer connection between the first client device and the second client device, the notification transmitted to the second client device.
Example 5 includes the apparatus of any one of examples 1-4, wherein the reduction in power consumption is a first reduction in power consumption, and the reduction in network bandwidth usage is a first reduction in network bandwidth usage, one or more of the at least one processor circuit to cause, in response to determining the first attendee is absent, adjustment to an operation of the first client device to achieve at least one of (i) a second reduction in power consumption associated with the conference call relative to before the first attendee went absent or (ii) a second reduction in network bandwidth usage associated with the conference call relative to before the first attendee went absent.
Example 6 includes the apparatus of example 5, wherein the adjustment to the operation of the first client device achieves the first reduction in power consumption, the first reduction in power consumption based on at least one of (i) turning off a microphone associated with the first client device, (ii) turning off a camera associated with a first client device, (iii) lowering a data rate of audio captured by the microphone, (iv) lowering a frame rate of video captured by the camera, (v) stopping a processing of incoming media received from the second client device.
Example 7 includes the apparatus of any one of examples 5 or 6, wherein the notification is a first notification, and one or more of the at least one processor circuit is to, in response to determining the first attendee is present at the first client device following a determination that the first attendee was absent reverse the adjustment to the operation of the first client device, and cause transmission of a second notification that indicates the first attendee is present.
Example 8 includes the apparatus of any one of examples 1-7, wherein the notification indicates a level of engagement of the first attendee in the conference call.
Example 9 includes the apparatus of example 8, wherein the level of engagement corresponds to at least one of (i) completely disengaged from the conference call, (ii) engaged in audio of the conference call but not video of the conference call, or (iii) fully engaged in the conference call.
Example 10 includes the apparatus of any one of examples 1-9, wherein the reduction in power consumption is a first reduction in power consumption, the reduction in network bandwidth usage is a first reduction in network bandwidth usage, and the notification is a first notification, one or more of the at least one processor circuit to receive information associated with a second notification from the second client device, the information to indicate that a second attendee is absent from the second client device, and in response to receiving the information, cause an adjustment to an operation of the first client device to achieve at least one of (i) a second reduction in power consumption associated with the conference call relative to before the second attendee went absent or (ii) a second reduction in network bandwidth usage associated with the conference call relative to before the second attendee went absent.
Example 11 includes the apparatus of example 10, wherein the adjustment to the operation of the first client device achieves the second reduction in power consumption, the second reduction in power consumption based on at least one of (i) stopping a processing of incoming media from the second client device, (ii) turning off a microphone associated with the first client device, (iii) turning off a camera associated with a first client device, (iv) lowering a data rate of audio captured by the microphone, or (v) lowering a frame rate of video captured by the camera.
Example 12 includes a non-transitory machine readable storage medium comprising instructions to cause at least one processor circuit to at least determine whether a first attendee of a conference call is absent from a first client device connected to the conference call, and in response to determining the first attendee is absent, cause transmission of a notification that indicates the first attendee is absent, the notification to cause a second client device connected to the conference call to achieve at least one of (i) a reduction in power consumption associated with the conference call relative to before the first attendee went absent or (ii) a reduction in network bandwidth usage associated with the conference call relative to before the first attendee went absent.
Example 13 includes the non-transitory machine readable storage medium of example 12, wherein the first and second client devices are connected to the conference call via a server distinct from the first client device and distinct from the second client device, the notification transmitted to the server.
Example 14 includes the non-transitory machine readable storage medium of example 13, wherein the notification is not transmitted to the second client device.
Example 15 includes the non-transitory machine readable storage medium of any one of examples 12-14, wherein the conference call is implemented via a peer-to-peer connection between the first client device and the second client device, the notification transmitted to the second client device.
Example 16 includes the non-transitory machine readable storage medium of any one of examples 12-15, wherein the reduction in power consumption is a first reduction in power consumption, and the reduction in network bandwidth usage is a first reduction in network bandwidth usage, the instructions to cause one or more of the at least one processor circuit to cause, in response to determining the first attendee is absent, adjustment to an operation of the first client device to achieve at least one of (i) a second reduction in power consumption associated with the conference call relative to before the first attendee went absent or (ii) a second reduction in network bandwidth usage associated with the conference call relative to before the first attendee went absent.
Example 17 includes the non-transitory machine readable storage medium of example 16, wherein the adjustment to the operation of the first client device achieves the first reduction in power consumption, the first reduction in power consumption based on at least one of (i) turning off a microphone associated with the first client device, (ii) turning off a camera associated with a first client device, (iii) lowering a data rate of audio captured by the microphone, (iv) lowering a frame rate of video captured by the camera, (v) stopping a processing of incoming media received from the second client device.
Example 18 includes the non-transitory machine readable storage medium of any one of examples 16 or 17, wherein the notification is a first notification, the instructions to cause one or more of the at least one processor circuit to, in response to determining the first attendee is present at the first client device following a determination that the first attendee was absent reverse the adjustment to the operation of the first client device, and cause transmission of a second notification that indicates the first attendee is present.
Example 19 includes the non-transitory machine readable storage medium of any one of examples 12-18, wherein the notification indicates a level of engagement of the first attendee in the conference call.
Example 20 includes the non-transitory machine readable storage medium of example 19, wherein the level of engagement corresponds to at least one of (i) completely disengaged from the conference call, (ii) engaged in audio of the conference call but not video of the conference call, or (iii) fully engaged in the conference call.
Example 21 includes the non-transitory machine readable storage medium of any one of examples 12-20, wherein the reduction in power consumption is a first reduction in power consumption, the reduction in network bandwidth usage is a first reduction in network bandwidth usage, and the notification is a first notification, the instructions to cause one or more of the at least one processor circuit to receive information associated with a second notification from the second client device, the information to indicate that a second attendee is absent from the second client device, and in response to receiving the information, cause an adjustment to an operation of the first client device to achieve at least one of (i) a second reduction in power consumption associated with the conference call relative to before the second attendee went absent or (ii) a second reduction in network bandwidth usage associated with the conference call relative to before the second attendee went absent.
Example 22 includes the non-transitory machine readable storage medium of example 21, wherein the adjustment to the operation of the first client device achieves the second reduction in power consumption, the second reduction in power consumption based on at least one of (i) stopping a processing of incoming media from the second client device, (ii) turning off a microphone associated with the first client device, (iii) turning off a camera associated with a first client device, (iv) lowering a data rate of audio captured by the microphone, or (v) lowering a frame rate of video captured by the camera.
Example 23 includes a method comprising determining whether a first attendee of a conference call is absent from a first client device connected to the conference call, and transmitting, in response to determining the first attendee is absent, of a notification that indicates the first attendee is absent, the notification to cause a second client device connected to the conference call to achieve at least one of (i) a reduction in power consumption associated with the conference call relative to before the first attendee went absent or (ii) a reduction in network bandwidth usage associated with the conference call relative to before the first attendee went absent.
Example 24 includes the method of example 23, wherein the first and second client devices are connected to the conference call via a server distinct from the first client device and distinct from the second client device, the notification transmitted to the server.
Example 25 includes the method of example 24, wherein the notification is not transmitted to the second client device.
Example 26 includes the method of any one of examples 23-25, wherein the conference call is implemented via a peer-to-peer connection between the first client device and the second client device, the notification transmitted to the second client device.
Example 27 includes the method of any one of examples 23-26, wherein the reduction in power consumption is a first reduction in power consumption, and the reduction in network bandwidth usage is a first reduction in network bandwidth usage, the method further including causing, in response to determining the first attendee is absent, adjustment to an operation of the first client device to achieve at least one of (i) a second reduction in power consumption associated with the conference call relative to before the first attendee went absent or (ii) a second reduction in network bandwidth usage associated with the conference call relative to before the first attendee went absent.
Example 28 includes the method of example 27, wherein the adjustment to the operation of the first client device achieves the first reduction in power consumption, the first reduction in power consumption based on at least one of (i) turning off a microphone associated with the first client device, (ii) turning off a camera associated with a first client device, (iii) lowering a data rate of audio captured by the microphone, (iv) lowering a frame rate of video captured by the camera, (v) stopping a processing of incoming media received from the second client device.
Example 29 includes the method of any one of examples 27 or 28, wherein the notification is a first notification, the method further including, in response to determining the first attendee is present at the first client device following a determination that the first attendee was absent reversing the adjustment to the operation of the first client device, and causing transmission of a second notification that indicates the first attendee is present.
Example 30 includes the method of any one of examples 23-29, wherein the notification indicates a level of engagement of the first attendee in the conference call.
Example 31 includes the method of example 30, wherein the level of engagement corresponds to at least one of (i) completely disengaged from the conference call, (ii) engaged in audio of the conference call but not video of the conference call, or (iii) fully engaged in the conference call.
Example 32 includes the method of any one of examples 23-31, wherein the reduction in power consumption is a first reduction in power consumption, the reduction in network bandwidth usage is a first reduction in network bandwidth usage, and the notification is a first notification, the method further including receiving information associated with a second notification from the second client device, the information to indicate that a second attendee is absent from the second client device, and in response to receiving the information, causing an adjustment to an operation of the first client device to achieve at least one of (i) a second reduction in power consumption associated with the conference call relative to before the second attendee went absent or (ii) a second reduction in network bandwidth usage associated with the conference call relative to before the second attendee went absent.
Example 33 includes the method of example 32, wherein the adjustment to the operation of the first client device achieves the second reduction in power consumption, the second reduction in power consumption based on at least one of (i) stopping a processing of incoming media from the second client device, (ii) turning off a microphone associated with the first client device, (iii) turning off a camera associated with a first client device, (iv) lowering a data rate of audio captured by the microphone, or (v) lowering a frame rate of video captured by the camera.
Example 34 includes an apparatus comprising interface circuitry, machine readable instructions, and at least one processor circuit to at least one of instantiate or execute the machine readable instructions to generate a composite signal for a conference call based on first media from a first client device connected to the conference call and second media from a second client device connected to the conference call, modify the composite signal in response to a notification from the first client device, the notification to indicate an attendee of the conference call is absent from the first client device, and transmit the modified composite signal to the second client device.
Example 35 includes the apparatus of example 34, wherein one or more of the at least one processor circuit is to cause transmission of information to the second client device to cause the second client device to achieve at least one of (i) a reduction in power consumption associated with the conference call relative to before the attendee went absent or (ii) a second reduction in network bandwidth usage associated with the conference call relative to before the attendee went absent, the information based on the notification.
Example 36 includes the apparatus of example 35, wherein the information includes the notification.
Example 37 includes the apparatus of any one of examples 35 or 36, wherein the information is to cause the second client device to at least one of (i) turn off a camera associated with the second client device, or (ii) lower a frame rate of video captured by the camera.
Example 38 includes the apparatus of any one of examples 34-37, wherein the modifying of the composite signal includes replacing a video stream of the attendee with an indication that the attendee is absent from the first client device.
Example 39 includes the apparatus of example 38, wherein the indication includes an avatar for the attendee.
Example 40 includes the apparatus of any one of examples 34-39, wherein one or more of the at least one processor circuit is to determine a level of engagement of the attendee based on the notification, and cause transmission of the modified composite signal to the first client device based on the level of engagement.
Example 41 includes the apparatus of example 40, wherein the modified composite signal is not sent to the first client device when the level of engagement corresponds to the attendee being completely disengaged.
Example 42 includes the apparatus of any one of examples 40 or 41, wherein an audio portion of the modified composite signal is sent to the first client device without sending a video portion when the level of engagement corresponds to the attendee being engaged only in audio of the conference call.
Example 43 includes the apparatus of any one of examples 40 or 42, wherein one or more of the at least one processor circuit is to cause transmission of the modified composite signal to the first client device when the level of engagement corresponds to the attendee being fully engaged in the conference call.
Example 44 includes a non-transitory machine readable storage medium comprising instructions to cause at least one processor circuit to at least generate a composite signal for a conference call based on first media from a first client device connected to the conference call and second media from a second client device connected to the conference call, modify the composite signal in response to a notification from the first client device, the notification to indicate an attendee of the conference call is absent from the first client device, and transmit the modified composite signal to the second client device.
Example 45 includes the non-transitory machine readable storage medium of example 44, wherein one or more of the at least one processor circuit is to cause transmission of information to the second client device to cause the second client device to achieve at least one of (i) a reduction in power consumption associated with the conference call relative to before the attendee went absent or (ii) a second reduction in network bandwidth usage associated with the conference call relative to before the attendee went absent, the information based on the notification.
Example 46 includes the non-transitory machine readable storage medium of example 45, wherein the information includes the notification.
Example 47 includes the non-transitory machine readable storage medium of any one of examples 45 or 46, wherein the information is to cause the second client device to at least one of (i) turn off a camera associated with the second client device, or (ii) lower a frame rate of video captured by the camera.
Example 48 includes the non-transitory machine readable storage medium of any one of examples 44-47, wherein the modifying of the composite signal includes replacing a video stream of the attendee with an indication that the attendee is absent from the first client device.
Example 49 includes the non-transitory machine readable storage medium of example 48, wherein the indication includes an avatar for the attendee.
Example 50 includes the non-transitory machine readable storage medium of any one of examples 44-49, wherein one or more of the at least one processor circuit is to determine a level of engagement of the attendee based on the notification, and cause transmission of the modified composite signal to the first client device based on the level of engagement.
Example 51 includes the non-transitory machine readable storage medium of example 50, wherein the modified composite signal is not sent to the first client device when the level of engagement corresponds to the attendee being completely disengaged.
Example 52 includes the non-transitory machine readable storage medium of any one of examples 50 or 51, wherein an audio portion of the modified composite signal is sent to the first client device without sending a video portion when the level of engagement corresponds to the attendee being engaged only in audio of the conference call.
Example 53 includes the non-transitory machine readable storage medium of any one of examples 50 or 52, wherein one or more of the at least one processor circuit is to cause transmission of the modified composite signal to the first client device when the level of engagement corresponds to the attendee being fully engaged in the conference call.
Example 54 includes a method comprising generating a composite signal for a conference call based on first media from a first client device connected to the conference call and second media from a second client device connected to the conference call, modifying the composite signal in response to a notification from the first client device, the notification to indicate an attendee of the conference call is absent from the first client device, and transmitting the modified composite signal to the second client device.
Example 55 includes the method of example 54, further including transmitting information to the second client device to cause the second client device to achieve at least one of (i) a reduction in power consumption associated with the conference call relative to before the attendee went absent or (ii) a second reduction in network bandwidth usage associated with the conference call relative to before the attendee went absent, the information based on the notification.
Example 56 includes the method of example 55, wherein the information includes the notification.
Example 57 includes the method of any one of examples 55 or 56, wherein the information is to cause the second client device to at least one of (i) turn off a camera associated with the second client device, or (ii) lower a frame rate of video captured by the camera.
Example 58 includes the method of any one of examples 54-57, wherein the modifying of the composite signal includes replacing a video stream of the attendee with an indication that the attendee is absent from the first client device.
Example 59 includes the method of example 58, wherein the indication includes an avatar for the attendee.
Example 60 includes the method of any one of examples 54-59, further including determining a level of engagement of the attendee based on the notification, and transmitting the modified composite signal to the first client device based on the level of engagement.
Example 61 includes the method of example 60, wherein the modified composite signal is not sent to the first client device when the level of engagement corresponds to the attendee being completely disengaged.
Example 62 includes the method of any one of examples 60 or 61, wherein an audio portion of the modified composite signal is sent to the first client device without sending a video portion when the level of engagement corresponds to the attendee being engaged only in audio of the conference call.
Example 63 includes the method of any one of examples 60-62, further including transmitting the modified composite signal to the first client device when the level of engagement corresponds to the attendee being fully engaged in the conference call.
Example 64 includes a first client device comprising interface circuitry, machine readable instructions, and at least one processor circuit to at least one of instantiate or execute the machine readable instructions to determine whether a first attendee of a conference call is absent from the first client device, and cause transmission of a notification to at least one of a server for the conference call or a second client device associated with the conference call and different from the first client device, the notification to cause the second client device to change an operating state associates with the conference call.
Example 65 includes the first client device of example 64, wherein the first client device is to cause transmission of the notification to the server.
Example 66 includes the first client device of example 65, wherein the notification is not transmitted to the second client device.
Example 67 includes the first client device of any one of examples 64-66, wherein the conference call is implemented via a peer-to-peer connection between the first client device and the second client device, the notification transmitted to the second client device.
Example 68 includes the first client device of any one of examples 64-67, wherein the change in the operating state is to reduce power consumption of the second client device.
Example 69 includes the first client device of any one of examples 64-68, wherein the change in the operating state is to reduce network bandwidth usage by the second client device.
Example 70 includes the first client device of any one of examples 64-69, wherein one or more of the at least one processor circuit is to cause adjustment to an operation of the first client device in response to determining the first attendee is absent, the adjustment including at least one of turning off a microphone associated with the first client device, turning off a camera associated with a first client device, lowering a data rate of audio captured by the microphone, lowering a frame rate of video captured by the camera, or stopping a processing of incoming media received from the second client device.
Example 71 includes the first client device of example 70, wherein the notification is a first notification, and one or more of the at least one processor circuit is to, in response to determining the first attendee is present at the first client device following a determination that the first attendee was absent reverse the adjustment to the operation of the first client device, and cause transmission of a second notification that indicates the first attendee is present.
Example 72 includes the first client device of any one of examples 64-71, wherein the notification indicates a level of engagement of the first attendee in the conference call.
Example 73 includes the first client device of example 72, wherein the level of engagement corresponds to at least one of (i) completely disengaged from the conference call, (ii) engaged in audio of the conference call but not video of the conference call, or (iii) fully engaged in the conference call.
Example 74 includes the first client device of any one of examples 64-73, wherein the notification is a first notification, one or more of the at least one processor circuit to receive information associated with a second notification from the second client device, the information to indicate that a second attendee is absent from the second client device, and in response to receiving the information, cause an adjustment to an operation of the first client device to reduce a power consumption of the first client device associated with a connection to the conference call or reduce network bandwidth usage by the first client device associated with the connection to the conference call.
Example 75 includes the first client device of example 74, wherein the adjustment to the operation of the first client device from caused by one or more of the at least one processor circuit includes at least one of stopping a processing of incoming media from the second client device, turning off a microphone associated with the first client device, turning off a camera associated with a first client device, lowering a data rate of audio captured by the microphone, or lowering a frame rate of video captured by the camera.
Example 76 includes a first client device comprising interface circuitry to connect the first client device to a conference call, machine readable instructions, and at least one processor circuit to at least one of instantiate or execute the machine readable instructions to determine, based on information transmitted from a second client device connected to the conference call, that an attendee of the conference call is absent from the second client device, and adjust an operating state of the first client device associated with the conference call based on the absent attendee.
Example 77 includes the first client device of example 76, wherein the information includes an indication of a level of engagement of the attendee in the conference call, the adjustment of the operating state of the first client device based on the level of engagement of the attendee.
Example 78 includes a server to host conference calls, the server comprising interface circuitry, machine readable instructions, and at least one processor circuit to at least one of instantiate or execute the machine readable instructions to generate a composite signal for a conference call based on first media from a first client device connected to the conference call and based on second media from a second client device connected to the conference call, modify the composite signal in response to a notification from the first client device, the notification to indicate an attendee of the conference call is absent from the first client device, and transmit the modified composite signal to the second client device.
Example 79 includes the server of example 78, wherein one or more of the at least one processor circuit is to cause transmission of information to the second client device to cause the second client device to at least one of reduce power consumption of the second client device associated with a connection to the conference call or reduce network bandwidth usage by the second client device associated with the connection to the conference call, the information based on the notification.
Example 80 includes the server of any one of examples 78 or 79, wherein one or more of the at least one processor circuit is to modify the composite signal by replacing a video stream of the attendee with an indication that the attendee is absent from the first client device.
Example 81 includes the server of any one of examples 78-80, wherein one or more of the at least one processor circuit is to determine a level of engagement of the attendee based on the notification, and cause transmission of the modified composite signal to the first client device based on the level of engagement.
Example 82 includes the server of example 81, wherein the modified composite signal is not sent to the first client device when the level of engagement corresponds to the attendee being completely disengaged.
Example 83 includes the server of example 81, wherein an audio portion of the modified composite signal is sent to the first client device without sending a video portion when the level of engagement corresponds to the attendee being engaged only in audio of the conference call.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A first client device comprising:
interface circuitry;
machine readable instructions; and
at least one processor circuit to at least one of instantiate or execute the machine readable instructions to:
determine whether a first attendee of a conference call is absent from the first client device; and
cause transmission of a notification to at least one of a server for the conference call or a second client device associated with the conference call and different from the first client device, the notification to cause the second client device to change an operating state associates with the conference call.

2. The first client device of claim 1, wherein the first client device is to cause transmission of the notification to the server.

3. The first client device of claim 2, wherein the notification is not transmitted to the second client device.

4. The first client device of claim 1, wherein the conference call is implemented via a peer-to-peer connection between the first client device and the second client device, the notification transmitted to the second client device.

5. The first client device of claim 1, wherein the change in the operating state is to reduce power consumption of the second client device.

6. The first client device of claim 1, wherein the change in the operating state is to reduce network bandwidth usage by the second client device.

7. The first client device of claim 1, wherein one or more of the at least one processor circuit is to cause adjustment to an operation of the first client device in response to determining the first attendee is absent, the adjustment including at least one of turning off a microphone associated with the first client device, turning off a camera associated with a first client device, lowering a data rate of audio captured by the microphone, lowering a frame rate of video captured by the camera, or stopping a processing of incoming media received from the second client device.

8. The first client device of claim 7, wherein the notification is a first notification, and one or more of the at least one processor circuit is to, in response to determining the first attendee is present at the first client device following a determination that the first attendee was absent:
reverse the adjustment to the operation of the first client device; and
cause transmission of a second notification that indicates the first attendee is present.

9. The first client device of claim 1, wherein the notification indicates a level of engagement of the first attendee in the conference call.

10. The first client device of claim 9, wherein the level of engagement corresponds to at least one of (i) completely disengaged from the conference call, (ii) engaged in audio of the conference call but not video of the conference call, or (iii) fully engaged in the conference call.

11. The first client device of claim 1, wherein the notification is a first notification, one or more of the at least one processor circuit to:
receive information associated with a second notification from the second client device, the information to indicate that a second attendee is absent from the second client device; and
in response to receiving the information, cause an adjustment to an operation of the first client device to reduce a power consumption of the first client device associated with a connection to the conference call or reduce network bandwidth usage by the first client device associated with the connection to the conference call.

12. The first client device of claim 11, wherein the adjustment to the operation of the first client device from caused by one or more of the at least one processor circuit includes at least one of stopping a processing of incoming media from the second client device, turning off a microphone associated with the first client device, turning off a camera associated with a first client device, lowering a data rate of audio captured by the microphone, or lowering a frame rate of video captured by the camera.

13. A first client device comprising:
interface circuitry to connect the first client device to a conference call;
machine readable instructions; and
at least one processor circuit to at least one of instantiate or execute the machine readable instructions to:
determine, based on information transmitted from a second client device connected to the conference call, that an attendee of the conference call is absent from the second client device; and
adjust an operating state of the first client device associated with the conference call based on the absent attendee.

14. The first client device of claim 13, wherein the information includes an indication of a level of engagement of the attendee in the conference call, the adjustment of the operating state of the first client device based on the level of engagement of the attendee.

15. A server to host conference calls, the server comprising:
interface circuitry;
machine readable instructions; and
at least one processor circuit to at least one of instantiate or execute the machine readable instructions to:
generate a composite signal for a conference call based on first media from a first client device connected to the conference call and based on second media from a second client device connected to the conference call;
modify the composite signal in response to a notification from the first client device, the notification to indicate an attendee of the conference call is absent from the first client device; and
transmit the modified composite signal to the second client device.

16. The server of claim 15, wherein one or more of the at least one processor circuit is to cause transmission of information to the second client device to cause the second client device to at least one of reduce power consumption of the second client device associated with a connection to the conference call or reduce network bandwidth usage by the second client device associated with the connection to the conference call, the information based on the notification.

17. The server of claim 15, wherein one or more of the at least one processor circuit is to modify the composite signal by replacing a video stream of the attendee with an indication that the attendee is absent from the first client device.

18. The server of claim 15, wherein one or more of the at least one processor circuit is to:
determine a level of engagement of the attendee based on the notification; and
cause transmission of the modified composite signal to the first client device based on the level of engagement.

19. The server of claim 18, wherein the modified composite signal is not sent to the first client device when the level of engagement corresponds to the attendee being completely disengaged.

20. The server of claim 18, wherein an audio portion of the modified composite signal is sent to the first client device without sending a video portion when the level of engagement corresponds to the attendee being engaged only in audio of the conference call.
